(19) United States
(12) Patent Application Publication
(10) Pub. No.: US 2005/0222873 A1
(43) Pub. Date: Oct. 6, 2005

(54) Systems, methods and user interfaces for management and configuration of medical patient monitoring

(76) Inventors: Paul Nephin, Carleton Place (CA); Don Waterman, Appleton (CA); John Schneider, Kanata (CA); Evan Trickey, Carleton Place (CA)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/095,968

(22) Filed: Mar. 31, 2005

Related U.S. Application Data
(60) Provisional application No. 60/564,985, filed on Apr. 26, 2004.
(60) Provisional application No. 60/557,714, filed on Mar. 31, 2004.

(51) Int. Cl. G06F 17/60; G06F 17/30

(52) U.S. Cl. 705/2; 707/9

(57) ABSTRACT

Systems, methods and user interfaces for configuration of medical patient monitoring and configuration systems are disclosed. At a central database in which patient information, health care provider information and health care group information may be stored, patient information is associated with health care provider information, which is associated with health care group information. When stored information is accessed, patient information is displayed with its associated health care provider information, and health care provider information is displayed with its associated health care group information. Systems, methods, and user interfaces for customizing per-patient and standardized user prompts are also disclosed.

### CROSS-REFERENCE TO RELATED APPLICATIONS

This application claims the benefit of U.S. Provisional Patent Application Ser. No. 60/557,714, entitled “MEDICAL PATIENT MONITORING AND DATA INPUT SYSTEMS, METHODS AND USER INTERFACES”, filed on Mar. 31, 2004, and of U.S. Provisional Patent Application Ser. No. 60/564,985, entitled “MEDICAL PATIENT MONITORING AND CONFIGURATION SYSTEMS, METHODS AND USER INTERFACES”, filed on Apr. 26, 2004. The entire contents of these provisional applications, including the specifications and drawings thereof, are hereby incorporated by reference into the present application.

This application is also related to International (PCT) applications <Attorney Docket No. 51188-2> entitled “MEDICAL PATIENT MONITORING AND DATA INPUT SYSTEMS, METHODS AND USER INTERFACES”, and <Attorney Docket No. 51188-3> entitled “MEDICAL PATIENT MONITORING SYSTEMS, METHODS AND USER INTERFACES”, filed of even date herewith. The entire contents of these International applications are also incorporated herein by reference.

### FIELD OF THE INVENTION

This invention relates generally to medical patient monitoring and, in particular, to patient monitoring systems and methods, and configuration thereof.

### BACKGROUND

Monitoring of medical patients after release from hospital or for ongoing assessment of a medical condition, for example, presents many challenges. Attending medical appointments at a health care facility may not be convenient for a patient, such as when a medical condition or injury affects a patient's mobility or ability to travel. Where a desired or required level of monitoring involves relatively frequent determination of vital signs or other indicators of patient health, such visits to a health care facility may not be feasible.

In the field of remote health care monitoring, several systems are currently available. In one such system, predetermined health care questions and medication reminders are stored on an electronic device which is deployed at a patient site, typically the patient's home. The patient is prompted to answer the questions, and possibly to take medications or perform other tasks such as taking readings using any of a number of medical devices, including a stethoscope or glucometer, for example. Answers to the questions and readings from the devices may then be transmitted to a remote location for subsequent retrieval and analysis by a health care provider.

Although this type of remote monitoring system provides an alternative to attendance of medical appointments for patient monitoring, currently available systems have significant restrictions.

Conventional remote monitoring systems tend to be relatively rigid in regard to the particular questions that may be selected or otherwise stored on a patient device. Normally, questions from a predetermined list are programmed into the patient device. These systems provide little if any capacity for a user at a server where patient questionnaires are configured, for example, to modify questionnaire contents for different patients or medical conditions.

A further shortcoming of known remote monitoring systems relates to the management and presentation of patient information stored at a server. Stored patient information is generally not presented in a manner from which relationships between patients and health care providers, for instance, would be apparent.

### SUMMARY OF THE INVENTION

Embodiments of the invention address at least some of the above disadvantages of conventional remote patient monitoring techniques.

In accordance with one aspect of the invention, the design of custom patient questionnaires is improved. Patient questions may be selected from predetermined question lists or manually entered by a health care provider or administrator. The design of patient questionnaires may also be improved by presenting potential questions to a health care provider in a manner which clearly indicates a logical “nesting” or follow-on relationship between particular questions and responses to preceding questions.

According to a still further aspect of the invention, there is provided a user interface for a remote system at which patient information, including information collected at a patient monitoring system, is stored. Through the user interface, patient information may be accessed and configured at the remote system.

According to an aspect of the invention, there is provided a system for managing information in a medical patient health monitoring system. The system includes a data store for storing health care group information, health care provider information, and medical patient information, and a server operatively coupled to the data store. The server is configured to receive information for storage in the data store and to store the received information in the data store as at least one of: group information associated with a health care group, health care provider information associated with both a health care provider and a health care group to which the health care provider is assigned, and patient information associated with both a patient and a health care provider to which the patient is assigned, according to a type of the received information.

The information may be received from any of a local input device and a remote system.

In some embodiments, the system also includes a display, with the server being further configured to display on the display a graphical user interface (GUI) comprising a graphical element defining a user input area. The received information may then be a user input within the user input area. The display may be provided at the server or at a remote system which is configured to detect the user input within the user input area and to transmit the user input to the server.

According to one particular embodiment, the GUI is associated with a record in the data store, and the server is configured to store the received information in the record. The record may correspond to group information, care provider information, or patient information, and the GUI may include an indication of whether the user input area corresponds to group information, care provider information, or patient information.

A method of managing medical patient health care information is also provided, and includes receiving information to be stored in a database for storing health care group information, health care provider information, and medical patient information, determining whether the received information comprises health care group information, health care provider information, or patient information, and storing the received information in the database as group information associated with a health care group, as health care provider information associated with both a health care provider and a health care group to which the health care provider is assigned, or as patient information associated with both a patient and a health care provider to which the patient is assigned, based on the determination.

In some embodiments, the method further includes displaying a GUI comprising information stored in the database and a control input area, detecting a user input within the control input area, and displaying a further GUI defining a user input area. In this case, receiving may involve detecting a user input within the user input area.

There is also provided a machine-readable medium storing a data structure which includes a health care group record comprising information associated with a health care group, a health care provider record associated with the health care group record and comprising information associated with a health care provider, and a patient record associated with the health care provider record and comprising information associated with a medical patient.

The data structure may include multiple health care group records, multiple health care provider records, each associated with a health care group record and comprising information associated with respective health care providers, and multiple patient records, each associated with a health care provider record and comprising information associated with respective patients.

According to another aspect of the invention, a medical health monitoring system includes a data store and an access system. The data store is for storing a central database of patient information for a medical patient, health care provider information for a health care provider of the patient, and health care group information for a health care group to which the health care provider belongs. The access system is for accessing the data store and displaying the patient information, the health care provider information, and the health care group information, and is configured to display with health care provider information for a health care provider health care group information for the health care group to which the health care provider belongs, and to display with patient information for a patient health care provider information for the health care provider of the patient.

The access system may include a server operatively coupled to the data store and/or a remote system configured to communicate with the server to access the database.

In one embodiment, access to the database is controlled based on accounts established at the server, and the server displays or provides to the remote system information stored in the database, based on a type of access account used to access the database.

A method of providing access to medical health information, according to another aspect of the invention, includes determining an access level of a user attempting to access the health information, allowing the user to select patient information for a medical patient, health care provider information for a health care provider, or health care group information based on the access level, and displaying patient information with health care provider information for a health care provider of the patient responsive to selection of patient information, displaying health care provider information for a health care provider with health care group information for a health care group to which the health care provider belongs responsive to selection of health care provider information, and displaying health care group information responsive to selection of health care group information.

The operation of allowing may involve displaying one of a health care group information management graphical user interface (GUI), a health care provider information management GUI, or a patient information management GUI, each GUI comprising user input areas for controlling GUI presentation.

A graphical user interface for a health information management system is also provided, and includes an information graphical element and a situational reference graphical element. The information graphical element is for displaying patient information for a medical patient, health care provider information for a health care provider, or health care group information for a health care group stored in a medical information database. The situational reference graphical element is for displaying health care provider information for a health care provider associated with the patient where the information graphical element displays patient information, and for displaying health care group information for a health care group associated with the health care provider where the information graphical element displays health care provider information.

A further aspect of the invention provides a system of configuring user prompts to be presented at a medical patient health monitoring system. The system includes a display, an input device, and a user prompt configuration manager for displaying on the display existing user prompts in a user prompt set, for receiving from the input device a user input of a new user prompt for the user prompt set, and for adding the new user prompt to the user prompt set.

The user prompt configuration manager may be configured to display graphical elements defining respective control input areas corresponding to a plurality of types of user prompts, to detect as a new user prompt control entry input a user input within any of the control input areas, and to display on the display a new user prompt input graphical element responsive to detecting a user input within any of the control input areas.

The existing user prompts may include user prompts in a standardized data set available for use in configuring user prompts for a plurality of patients, user prompts assigned to the patient, or both.

According to one embodiment, displaying involves displaying respective user prompt graphical elements and corresponding response graphical elements representing permitted responses to each existing user prompt. Respective subordinate user prompt graphical elements, comprising existing user prompts to be presented at the medical patient health monitoring system upon respective predetermined responses to other existing user prompts, are preferably associated on the display with the response graphical elements of the respective predetermined responses to the other user prompt.

Associating may involve displaying each subordinate user prompt graphical element and its corresponding response graphical element with at least one of: a common display attribute, a common vertical display position, and a common horizontal display position.

The response graphical elements may comprise control input graphical elements defining respective control input areas. In this case, the user prompt configuration manager is preferably further configured to display on the display a new user prompt input graphical element responsive to detecting a user input within any of the control input areas, and to associate a new user prompt, entered using the new user prompt input graphical element, on the display with the response graphical element comprising the control input graphical element which defines the control input area in which the user input was detected.

A method of configuring user prompts to be presented at a medical patient health monitoring system, according to yet another aspect of the invention, includes displaying existing user prompts in a user prompt set, receiving an input of a new user prompt for the user prompt set, and adding the new user prompt to the user prompt set.

A graphical user interface is also provided, and includes a graphical element comprising user prompts to be presented at a medical patient health monitoring system, and an input graphical element defining an input area for configuring the user prompts.

The graphical element may include respective user prompt graphical elements comprising user prompts to be presented at the medical patient health monitoring system, respective response graphical elements comprising permitted responses to each user prompt, and respective subordinate user prompt graphical elements comprising user prompts to be presented at the medical patient health monitoring system upon predetermined responses to other user prompts, each subordinate user prompt being associated on a display with a response graphical element of a predetermined response to another user prompt.

Other aspects and features of embodiments of the present invention will become apparent to those ordinarily skilled in the art upon review of the following description of embodiments of the invention.

### BRIEF DESCRIPTION OF THE DRAWINGS

Examples of embodiments of the invention will now be described in greater detail with reference to the accompanying drawings, in which:

FIG. 1 is a block diagram of a patient monitoring system;

FIG. 2 is a block diagram of an illustrative example patient system;

FIG. 3 is a block diagram of an illustrative example server;

FIG. 4 is a block diagram of a server database data structure according to an embodiment of the invention;

FIG. 5 is a representation of an example server user login GUI;

FIG. 6 is a representation of an example server password change GUI;

FIG. 7 is a representation of an example server information management GUI;

FIG. 8 is a representation of an example group name edit GUI;

FIG. 9 is a representation of an example group contact telephone number entry GUI;

FIG. 10 is a representation of an example group contact address entry GUI;

FIG. 11 is a representation of an example health care provider information management GUI;

FIG. 12 is a representation of another example health care provider information management GUI;

FIG. 13 is a representation of an example patient system management GUI;

FIG. 14 is a representation of an example health care providers management GUI;

FIG. 15 is a representation of an example health care provider name entry GUI;

FIG. 16 is a representation of an example health care provider username and password assignment GUI;

FIG. 17 is a representation of an example health care provider details entry GUI;

FIG. 18 is a representation of an example patient assignment GUI;

FIG. 19 is a representation of an example patient information management GUI;

FIG. 20 is a representation of an example patient identity number entry GUI;

FIG. 21 is a representation of an example patient e-mail address entry GUI;

FIG. 22 is a representation of an example patient system assignment GUI;

FIG. 23 is a representation of an example patient list report;

FIG. 24 is a representation of an example patient profile management GUI;

FIG. 25 is a representation of an example patient contact information management GUI;

FIG. 26 is a representation of an example patient allergies management GUI;

FIG. 27 is a representation of an example patient diagnoses management GUI;

FIG. 28 is a representation of an example patient medications management GUI;

FIG. 29 is a representation of an example new allergy entry GUI;

FIG. 30 is a representation of an example patient medication entry GUI;

FIG. 31-34 are representations of example standardized user prompt set configuration GUIs;

FIGS. 35-38 are representations of GUIs for a server in accordance with embodiments of the invention;

FIG. 39 is a flow diagram of a method of configuring user prompts to be presented to a patient at a remote patient health monitoring system;

FIG. 40 is a representation of an example alert presentation GUI;

FIG. 41 is a representation of an example health care provider alert report;

FIG. 42 is a representation of an example patient health information management GUI;

FIG. 43 is a representation of an example patient health information notes presentation GUI;

FIG. 44 illustrates an example patient heath information graphical report function of the GUI of FIG. 42;

FIG. 45 is a representation of an example patient health information graphical report;

FIG. 46 is a representation of an example manual patient health information entry GUI;

FIG. 47 is a representation of an example patient user prompt response presentation GUI;

FIG. 48 is a representation of an example patient action/reminder compliance information presentation GUI;

FIG. 49 is a representation of an example televisit session management GUI;

FIG. 50 is a representation of an example televisit session information presentation GUI;

FIG. 51 is a representation of an example custom patient user prompt configuration GUI;

FIG. 52 is a representation of an example patient action/reminder management GUI;

FIG. 53 is a representation of an example patient action/reminder entry GUI;

FIG. 54 is a representation of an example patient event schedule management GUI;

FIG. 55 is a representation of an example patient vital sign monitoring event schedule entry GUI;

FIG. 56 is a representation of an example patient health status monitoring event schedule entry GUI;

FIG. 57 is a representation of an example patient action/reminder event schedule entry;

FIG. 58 is a representation of an example patient system data communication event schedule entry GUI;

FIG. 59 is a representation of an example patient alert criteria management GUI;

FIG. 60 is a representation of an example patient alert criteria definition GUI;

FIG. 61 is a representation of an example alert notification setup GUI;

FIG. 62 is a representation of an example report controls toolbar;

FIG. 63 is a representation of an example export report GUI; and

FIG. 64 is a flow diagram of a method of health care information management according to an embodiment of the invention.

### DETAILED DESCRIPTION OF PREFERRED EMBODIMENTS

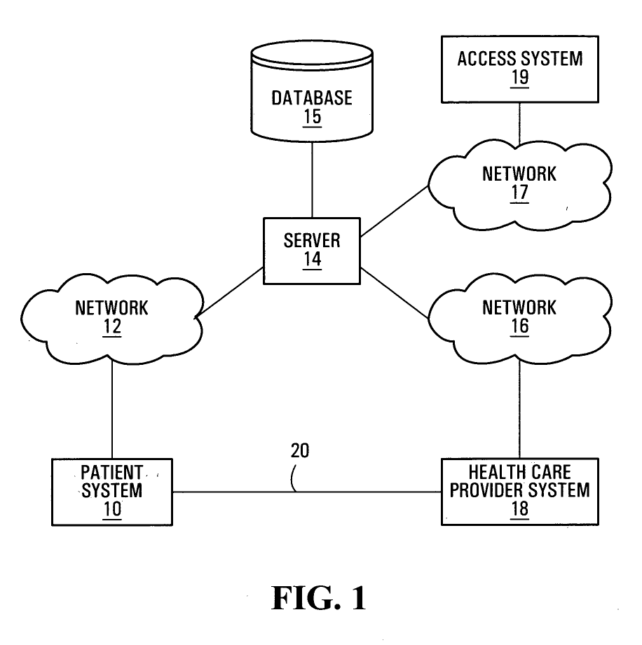

FIG. 1 is a block diagram of a patient monitoring system in which embodiments of the invention may be implemented. The system of FIG. 1 includes a patient system 10, a communication network 12, a server 14, a database 15 stored in a data store, a communication network 16, a health care provider system 18, a communication link 20, a communication network 17, and an access system 19. It should be appreciated, however, that the particular system shown in FIG. 1 is intended for illustrative purposes only, and that the invention is in no way limited thereto.

For example, it will become apparent from the following description that embodiments of the invention are not dependent upon any particular communication schemes, protocols, or network topologies. Those skilled in the art will appreciate that virtually any communication technique may be used to provide for communication between the system components shown in FIG. 1. It should also be appreciated that embodiments of the invention may be implemented in systems with further or fewer components than those explicitly shown in FIG. 1. A patient monitoring system may include many patient systems 10, multiple health care provider systems 18, multiple access systems 19, and even multiple servers 14 and/or databases 15.

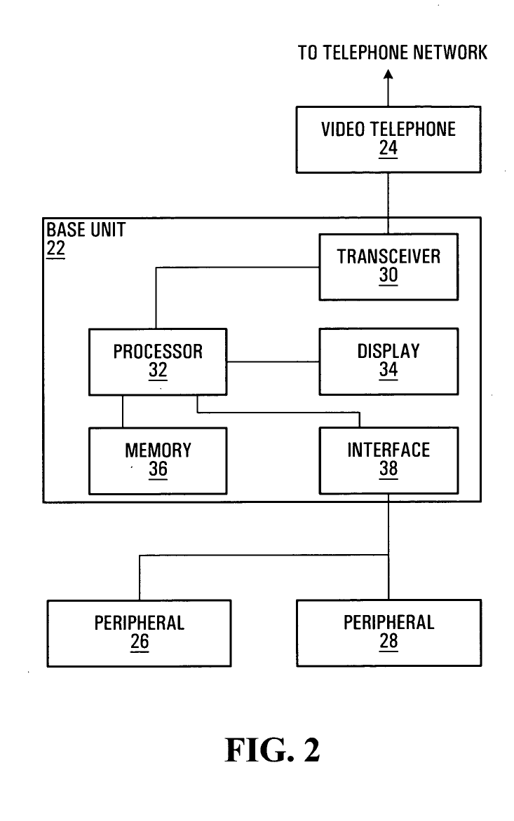

The patient system 10 is an electronic device intended for deployment at a patient site such as in the home of a patient. An example of such a system in described in further detail below in conjunction with FIG. 2.

The network 12 is a communication network through which the patient system 10 communicates with the server 14. In one embodiment, the network 12 is a public telephone network, although other types of communication networks and links will be apparent to those skilled in the art. It is also contemplated that different patient systems 10 may communicate with the server 14 through different networks or different types of networks. Given the sensitivity of medical information, a secure transfer mechanism is preferably implemented between the patient system 12 and the server 14.

The server 14 is a remotely accessible computer system with which the patient system 10, the health care provider system 18, and the access system 19 may establish communications and exchange information. According to a preferred embodiment, information may be exchanged in both directions between the server 14 and each of the patient station 10, the health care provider system 18, and the access system 19. Information stored in the database 15 at the server 14 may thereby be made accessible to these other systems, and information transmitted to the server 14 from these systems is preferably stored in the database 15.

The network 16 may be the same type, or even the same network, as the network 12, or a different type of network. In one embodiment, the network 12 is a telephone network, and the network 16 is a data communication network such as the Internet. Where the server 14 and the health care provider system 18 are co-located, at a hospital for instance, the network 16 may be a local area network (LAN). Different health care provider systems 18 may communicate with the server 14 through different networks or types of networks, and communications between the health care provider system 18 and the server 14 are preferably secure, using a Virtual Private Network (VPN) connection, for example.

The health care provider system 18 is a computer system, illustratively a personal computer, through which a health care provider interacts with the server 14 and the patient system 10 so as to remotely monitor one or more medical patients in their care.

Although shown as a direct connection, the communication link 20 may also be a network connection, through a telephone network, for example. The link 20 enables interaction between a health care provider and a patient, to conduct a remote, substantially real-time, medical assessment or “televisit” session. The health care provider is thereby able to actively assess current medical conditions of the patient without physically visiting the patient or requiring the patient to travel to a health care facility. For example, videotelephones or some other video conferencing equipment may be implemented at both the patient system 10 and the health care provider system 18 so that a televisit may include visual assessment of medical conditions.

An example of a health care provider system 18 and the operation thereof in conjunction with the patient system 10 are described in detail in the above-incorporated provisional patent application 60/557,714 and International application <Attorney Docket No. 51188-3>.

The network 17 may be the same type or the same network as the network 12 or the network 16. Alternatively, the network 17 may be a different type of network. In order to provide for access to the server 14 and the information stored in the database 15 from a wide range of geographical locations, the network 17 is preferably the Internet. The server 14 may also be accessible through multiple different types of network 17. As with the health care provider system 18 described above, communications between the access system 19 and the server 14 are preferably secure.

The access system 19 is a computer system through which a health care provider, and possibly other users, interact with the server 14. Although the same health care provider may use both the health care provider system 18, to interact with both the server 14 and the patient system 10, and the access system 19 to access the server 14, these systems may be associated with different health care providers. In one embodiment, the health care provider system 18 is used by a nurse for routine monitoring of patient health conditions, whereas the access system 19 is used by the patient's doctor. References to a health care provider herein should therefore be interpreted accordingly, to include a single health care provider or multiple health care providers responsible for a patient. A health care provider account may be accessible to more than one provider, including a patient's nurse and a patient's doctor in the above example. The access system 19 may be a personal computer, for example, provided with a browser through which a connection to or session with the server 14 may be established.

It should also be appreciated that access to the database 15 may be direct, as in the case of a user located at the server 14, or indirect, through the access system 19. In the latter case, a complete remote access system may be considered to include both the server 14 and a remote system 19.

According to one possible operating scheme, health care provider accounts are created on the server 14. A health care provider, using a provider account, then configures patient accounts or profiles, which may include any or all of: patient identification information, medical conditions, medication reminders, alert conditions for which a medical alert will be generated for the patient, the health care provider, or another health care provider for example, and a set of health questions to be used to periodically prompt the user for medical information. Health care provider alerts may be sent to a notification device such as a pager, to a health care provider email account accessible through the access system 19 or another computer system, or to some other device or system. Alerts may also involve manual operations such as a telephone call to a health care provider by a server administrator or other person monitoring the server 14 for generated alerts. In response to an alert, a health care provider may access the server 14 and the database 15 using the access system 19 to determine the conditions which caused the alert.

Configuration operations are described in further detail below.

Any or all patient information in a patient profile is preferably then loaded onto the patient system 10. For an initial deployment of the patient station 10, loading may be performed through a physical local connection to the server 14, whereas remote updates through the network 12 may be preferred where the patient system has already been deployed at the patient location. At least any medical reminders and questions are preferably loaded onto the patient system 10. Other patient profile information may also be loaded, at the discretion of the health care provider, for example.

Considering the patient system 10 in more detail, after the patient system 10 has been configured with health care instructions, which may include reminders and/or questions, the patient system 10 presents the instructions to the patient. FIG. 2 is a block diagram of an illustrative example of the patient system 10.

The patient system of FIG. 2 includes a base unit 22, which effectively provides an operating platform for the patient system and may operate with or without an optional videotelephone 24 and other optional peripheral devices 26, 28. The base unit 22 includes a transceiver 30, a processor 32, a display 34, a memory 36, and an interface 38. However, the present invention is not restricted to the particular implementation of a patient system shown in FIG. 2. Embodiments of the invention disclosed herein may be applied to patient systems which include fewer, further, or different components than those specifically shown in FIG. 2, with different interconnections therebetween.

The transceiver 30 enables information to be transmitted from and received by the base unit 22, although as described above, only a transmitter may be provided where information need only be sent from a patient system to a remote server such as the server 14 for instance. Those skilled in the art will appreciate that many different types of transceiver are suitable for use as the transceiver 30 in the base unit 22, including those for wired or wireless communications.

Although the videotelephone 24 is an optional component, the transceiver 30 is preferably compatible with the videotelephone 24. Such compatibility allows for deployment of substantially the same base unit 22, which may be configured, at deployment or subsequently, for operation with or without the videotelephone 24. In this manner, a videotelephone may be added to a patient system when required or removed from the patient system when visual monitoring of the patient is no longer required. Alternatively, different types of transceivers may be provided for respective connection to the videotelephone 24 and some other device through which communications may be established between the patient system and a remote system such as the server 14 or the health care provider system 18 (FIG. 1).

The processor 32 may be, for example, a microprocessor which is configured to execute patient system software for performing the operations described in further detail below. Normally, patient system software will be stored in the memory 36 and executed by the processor 32. Other implementations of the processor 32 are also contemplated. Display controllers, Application Specific Integrated Circuits (ASICs), and microcontrollers are illustrative examples of other types of component which may be implemented to provide functions of the processor 32. It should thus be apparent that embodiments of the invention may be implemented using software for execution by a processor, hardware, or some combination thereof.

The display 34 is a component which displays information to a patient. A liquid crystal display (LCD) is one common type of display for an electronic device such as the patient system. User inputs provided by a user of the patient system may be detected by the display 34, where the display is a touchscreen for instance, or by another component which detects an input stylus, such as a patient's finger or a component supplied with or configured for operation with the patient system, in proximity to an input area of the display 34. It is also contemplated that a user input device such as a keyboard, keypad, or mouse may be provided at a patient system.

The memory 36 is preferably a solid state memory. Other types of memory, such as a hard disk drive or a memory device which operates in conjunction with a removable recording medium, for example, may also be used as the memory 36. In another embodiment, the memory 36 includes more than one type of memory. As will become apparent from the following description of the operation of the patient system, the memory 36 may store any reminders and questions which have been configured for the patient, patient profile information, and inputs received from the patient. The memory 36 also preferably stores software to be executed by the processor 32, which may include operating system software and application software. Patient monitoring may instead be integrated within operating system software, for example.

The interface 38, although shown as a single component, may include multiple interfaces, and even different types of interface compatible with corresponding interfaces (not shown) in the peripherals 26, 28. Examples of the interface 38 include Bluetooth™ modules and other wireless communication interfaces, infrared ports, and Universal Serial Bus (USB) ports and other types of serial or parallel data ports, although the invention is in no way restricted to these types of interfaces. The interface 38 may also provide for further functions than communications with the peripherals 26, 28, such as power connections for providing power to operate the peripherals 26, 28 or to recharge batteries in the peripherals 26, 28. As described briefly above, the peripheral devices 26, 28 are optional. However, a base unit 22 which incorporates the interface 38 may be used with or without the peripherals 26, 28, to provide a dynamically configurable base unit 22.

The peripherals 26, 28 are preferably medical devices which may be used to collect health information or vital signs from the patient, including a blood pressure meter, an oximeter, a glucometer, a weigh scale, or a stethoscope, for instance. Other types of medical devices will be apparent to those skilled in the art.

A patient system preferably presents a patient with health instructions configured by a health care provider and loaded into the memory 36 of the patient system. The health instructions may include questions which prompt a user for information. Input of such information by the patient may be facilitated, for example, through input devices or by GUIs displayed on the display 34, such as the GUIs described in the above-incorporated provisional application 60/557,714 or International application <Attorney Docket No. 51188-2>.

For GUI-based input mechanisms, detection of user input may be enabled by using a touchscreen as the display 34, such that physical contact of a user input area in the GUI is detected. User input may instead be detected in such embodiments by sensing proximity of a stylus to the user input area. Other suitable input detection mechanisms, including those in which input detection is performed by a component or element that is separate from the display 34, will also be apparent to those skilled in the art.

User inputs and other information such as medical device readings collected at a patient system may be stored in the memory 36, transmitted through the transceiver 30 to the server 14 (FIG. 1) for storage in the database 15 and subsequent access by the health care provider system 18, transmitted to the health care provider system 18, and/or otherwise processed.

Audio presentation of user prompts, instructions, and other information at a patient system may also be provided through a speaker or other suitable audio output device. In a preferred embodiment, a translator is provided at the patient system to translate user prompts into corresponding audio prompts which are played to a patient through an audio output device. A translator may, for example, be a software module or utility that translates a user prompt data format, illustratively ASCII, into an audio signal format.

The preceding description relates primarily patient systems. In accordance with another embodiment of the invention, user interfaces for management of information stored at a server are provided.

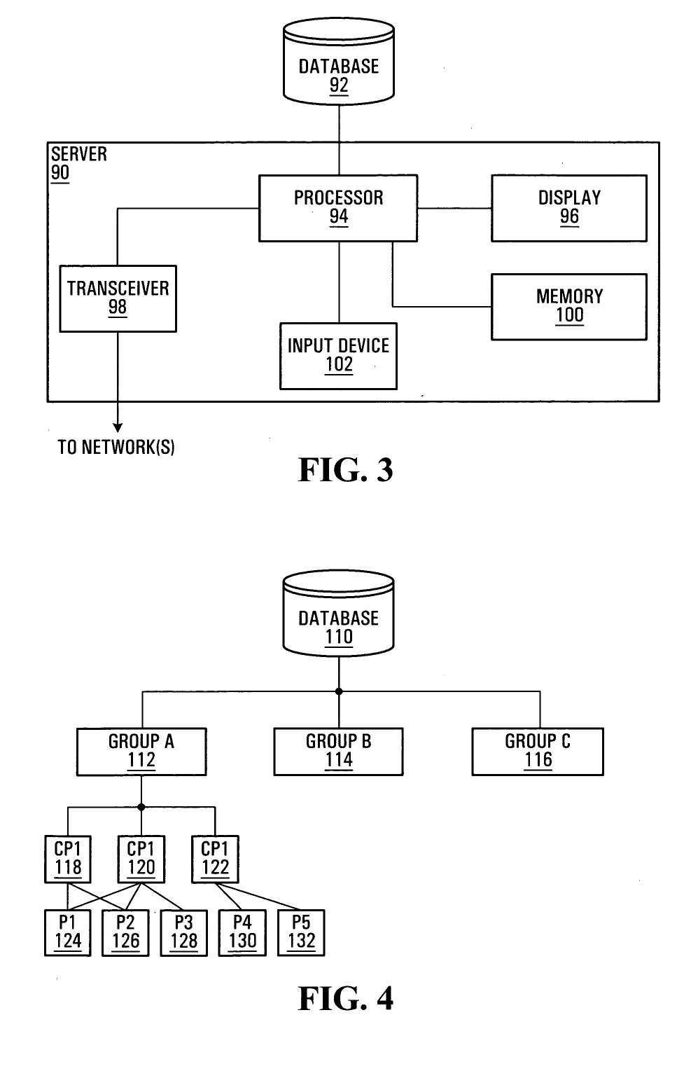

FIG. 3 is a block diagram of an illustrative example server 90, which includes a processor 94, a display 96, a transceiver 98, a memory 100, and an input device 102. The server 90 provides access, through authorized accounts such as health care provider or administrator accounts for instance, to a data store in which the database 92 is stored, to retrieve and store patient profile information, as described in further detail below.

The physical components shown in FIG. 3 are typical of server computers with which those skilled in the art will be familiar, although their operation in accordance with embodiments of the invention is new. Those skilled in the art will also appreciate that embodiments of the invention may be implemented in conjunction with other server arrangements than the specific arrangement shown in FIG. 3.

For example, the database 92 may be stored in an internal storage device in the server 90, or in an external but accessible storage device as shown. Similarly, depending upon the particular implementation of the server 90 and the database 92, the information management and configuration functions may be supported on a computer system external to the server 90, such as the access system 19 of FIG. 1. Such an external computer system preferably includes at least a processor, a display, an input device, and a communication interface through which the server may be accessed. Thus, it should be understood that information management and configuration need not necessarily be performed at a physical location of a server. These operations may be performed at the server or at an external computer system through which the server is accessible. References to information management functions of the server 90 should be interpreted accordingly.

It should also be understood that various functions of the processor 94 may be implemented using different hardware components. These functions may thus be implemented using hardware, software for execution by the processor 94, or some combination thereof.

The processor 94, the display 96, the memory 100, and the transceiver 98 may be substantially similar to the components described above with reference to FIG. 2, although the server 90 preferably includes, for example, a faster processor 94, a larger display 96 such as a computer monitor, a larger memory 100, and possibly a different type of transceiver 98. The server 90 may also incorporate different types of transceivers, including a transceiver compatible with the transceiver of each of a patient system a health care provider system, and an access system. Alternatively, a single transceiver 98 may support all communication functions of the server 90.

The input device 102 accepts inputs from a user, in this case a health care professional or server administrator. A keyboard and mouse represent common computer input devices, although other input devices may also or instead be provided for use in managing and configuring information.

Information stored in the database 92 may include patient information such as name and contact information, pictures, of patients or wounds for instance, and patient health information, as well as information relating to health care providers. In order to provide for remote monitoring of the patient, user prompts such as reminders and health questions may also be configured at the server 90 for storage in the database 92 and loading onto a patient system. A further embodiment of the invention guides a server user through the construction of a set of user prompts that are to be presented to the patient at the patient system. Currently known patient profile configuration techniques do not provide a clear and intuitive presentation of information stored at a server. Management and configuration of server database information in accordance with embodiments of the invention will become apparent from the following description.

Tele-healthcare as disclosed herein uses information and telecommunications technology to effectively provide healthcare services at a distance. Access to and management and configuration of data stored at a server is enabled through a software application and an Internet connection, for example. Health care providers can thereby view electronic records for patients enrolled in a remote monitoring program. Using a patient system, a patient is able to check his or her own vital signs and their general health on a daily basis and have the information transmitted to a remote system for analysis and storage. Health care providers can then review patient information and assess the condition of their patients, periodically or in response to alerts.

In accordance with an embodiment of the invention, access is provided to a repository of information concerning patients enrolled in a remote patient monitoring program. As described briefly above, such access may be provided at a server system at which information is stored, through a remote access system, or both.

FIG. 4 is a block diagram of a server database data structure according to an embodiment of the invention. The example data structure for a database 110 includes group records 112, 114, 116, health care provider (CP) records 118, 120, 122, and patient (P) records 124, 126, 128, 130, 132. It should be appreciated that the data structure of FIG. 4 is intended for illustrative purposes only, and that the invention is not limited thereto. For example, fewer or further groups, care providers, and patients may be provided in a complete patient monitoring system.

Looking at the data structure model of FIG. 4 from the bottom up, the patient records 124-132, which include patient information, form the foundation of the model. Moving up a level in the model, one or more health care providers associated with respective health care provider records 118-122 manage the patients and their information. A health care provider may be a physician, nurse, or other health practitioner responsible for monitoring information concerning patients.

The patients and the care providers belong to a group, which may represent a health care organization, for example. The database 110 can service one or more groups, and includes three groups in the example of FIG. 4. These groups, although serviced by the same database 110, are preferably distinct and may be unrelated to each other. The day-to-day patient management and monitoring is preferably performed within the groups without any sharing of information between them.

Database users are individuals that have been given access to the database 110. In one embodiment, there are three kinds of users, which may be considered user types, and each individual user is assigned to one of the following types: system administrators (SAs), group administrators (GAs), and care providers (CPs). The user type defines access functions and features available to the user. The role of each type of user and their associated access functions and features are described in detail below.

The database 110 is preferably accessible directly at a server or remotely through a network such as the Internet. Access through the Internet may be accomplished through an Internet browser and a Uniform Resource Locator (URL) or address of a server supporting the database 110.

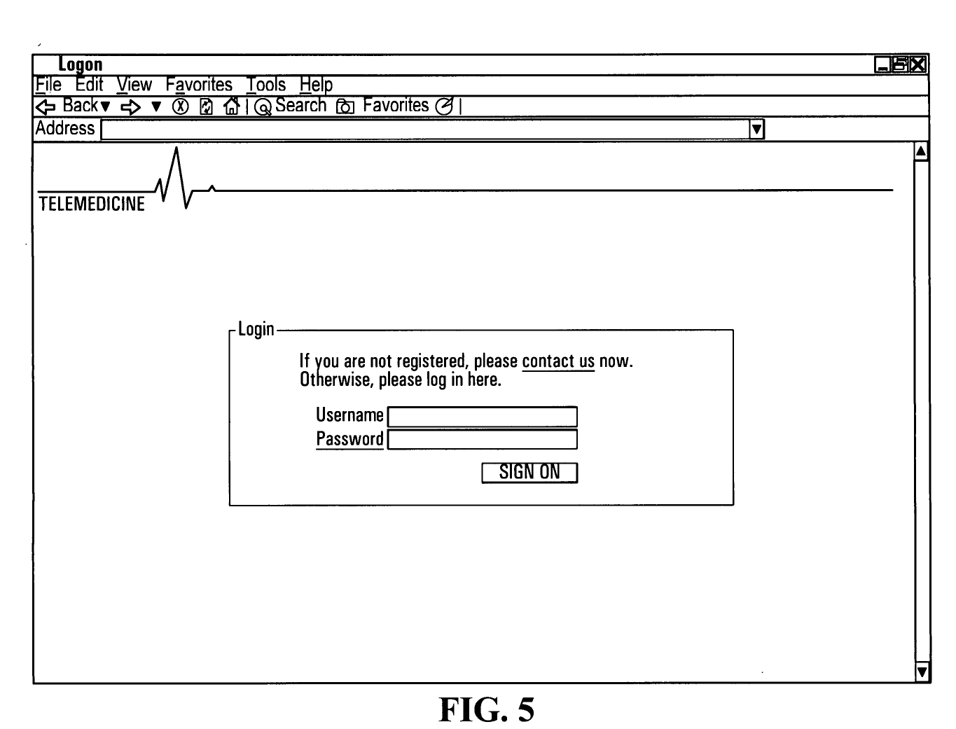

In order to protect database information from unauthorized access, access control is preferably provided. In one embodiment, access control is provided through a username and password-based login. An example user login GUI, which provides username and password input fields or areas of the display within which user inputs are detected, is shown in FIG. 5.

For security reasons, it is generally recommended that server users change their passwords on a regular basis. This may be accomplished, for example, by clicking a mouse pointer on a password label in the login GUI of FIG. 5, right clicking a mouse pointer in the password entry field in the login GUI of FIG. 5 to display a pop-up menu, or through some other mechanism for invoking a change password function.

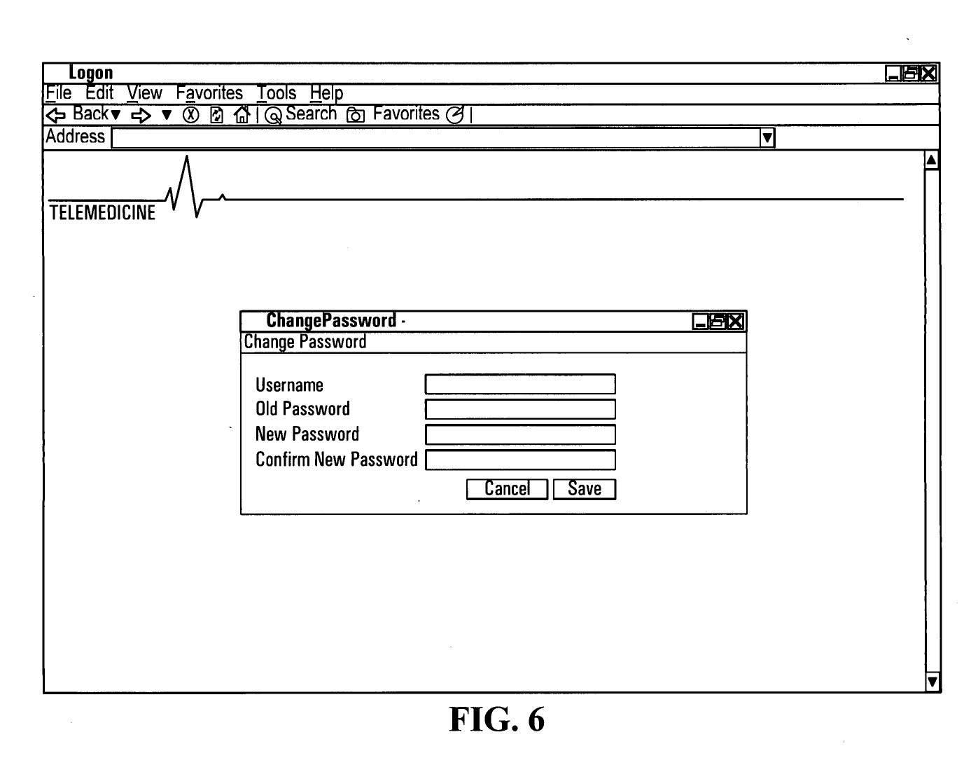

FIG. 6 is a representation of an example server password change GUI, which may be displayed as a pop-up window for instance and similarly defines user input fields or areas within which user inputs may be detected. In this GUI, a password change may be effected by entering a username and current password in the username and password fields, a new password in the new password and confirm new password fields and clicking on the save button. This series of operations may also automatically log a user into a database or server.

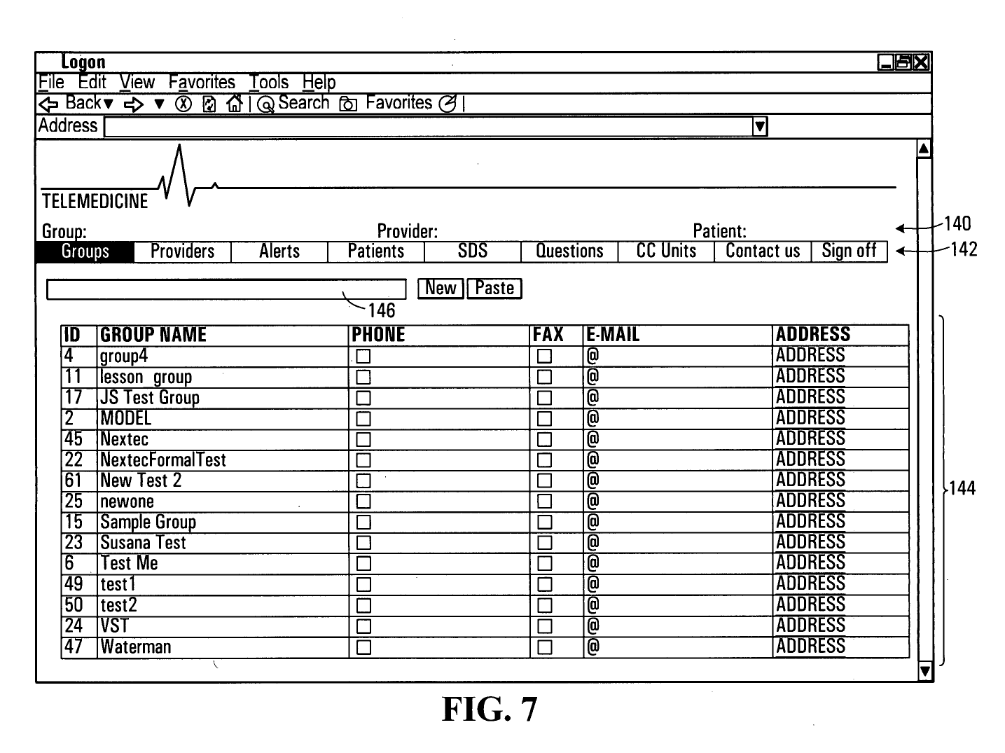

After a server user has logged into an account, information is presented according to user type associated with the user account. FIG. 7 is a representation of an example server information management GUI. Although the particular GUI in FIG. 7 is for a system administrator, GUIs for other server user types include similar basic characteristics.

The GUI of FIG. 7 includes graphical elements 140 representing situational reference fields, which show the names of a currently selected group, provider, and patient, depending upon the type and level of information selected for presentation and management.

A feature tab line is also presented in the GUI of FIG. 7, as graphical elements 142 showing the features available to the server user. These graphical elements, tabs in FIG. 7, allow quick navigation to particular features. User inputs within input areas defined by the graphical elements 142, such as a mouse button click while a mouse pointer is positioned within an input area, are detected, and the feature corresponding to the input area is invoked. In one embodiment, the selected feature tab remains highlighted to provide an indication of a currently selected feature.

The “body” of the GUI of FIG. 7 includes a graphical element 144 which may include either or both of user input and display fields associated with the selected main feature.

The graphical element 146 and its associated control graphical elements, shown as buttons in FIG. 7, allow new database entries to be added.

According to an embodiment of the invention, user inputs detected within information management GUIs cause display of information configuration or presentation GUIs, as described in further detail below. Users data entry may be facilitated, for example, by graphical elements defining input fields or areas in pop-up dialog boxes. As will be apparent, some fields may be mandatory, whereas other optional fields may be left blank.

A system administrator is the person or persons designated to manage the server and the database. One primary function of the system administrator is to manage the health care groups by creating health care groups and creating care providers associated with the groups. Health care group creation is performed, for example, when a new group enrols in a remote patient monitoring network or service. Within a new group, the system administrator generally creates one care provider entry for an individual designated by the group to act as the group administrator. This allows the group administrator to access the database, and to create other care providers in the group for instance. Group administrator functions are described in further detail below.

System administrators may also edit group and care provider information and maintain lists of patient systems assigned to the groups.

Although system administrators might not normally be tasked with management responsibilities associated with lower-level users in most organizations, the system administrator may have a set of permissions allowing access to functions expected to be performed by group administrators or care providers, such as managing patient records, viewing and managing patient alerts, and managing standardized user prompt data sets, for example.

When a system administrator logs into a server account, the GUI of FIG. 7 is preferably presented. This GUI lists all of the health care groups which have been created in the server database. The groups may be listed in alphabetical order based on group name, or sorted in order of some other, possibly selectable, characteristic such as group size, creation date, or latest activity date. Using this GUI, the system administrator can create new groups, edit existing group information and navigate to the individual group GUIs.

To perform any function with a group, the group is first selected, by clicking on the ID field of the group, for example, or proving a user input within an input area defined by a graphical element of the GUI associated with the group. Thus, a GUI may define control input areas corresponding to each editable field, for example. The group name of the selected group is displayed in the situational reference fields at 140. A blank group field indicates that no group is currently selected.

Specific group fields, excepting the ID field, may be indicated in the group information management GUI by underlining, for example. Selecting an editable field selects the group and preferably causes a field entry GUI such as a field-specific pop-up dialog to be displayed. The field entry GUI allows data to be edited or entered into the fields.

Each group record displayed in the graphical element 144 provides basic information related to that group. In the example GUI of FIG. 7, this basic information includes a unique group ID and group name assigned when the group is created, and a group contact telephone number, fax number, e-mail, and address.

To create a new health care group, a system administrator enters a name of the new group into the data entry field 146. The “New” button, or a similar control graphical element, is then selected to create a new group record, which is displayed as a new line in the group list in the graphical element 144. To complete the new group, profile fields in information entry GUIs are populated, as described below.

Health care groups may also be deleted, for example, by clicking on a group ID to select the group and then clicking on the “Delete” button when the name of the selected group appears in the graphical element 146. A confirmation window may also be provided to confirm that the group should be deleted. A deleted group is preferably removed from the group list.

In one embodiment, a group is either permanently or temporarily deleted. Information that is permanently deleted is removed from the database, such as where there was no provider or patient data associated with the group when it was deleted. If the group was inadvertently deleted, the group information may be re-entered. With a temporary delete function, group information is retained in the database. This function may be preferred where there was some provider or patient data associated with the group when it was deleted. The group information, although no longer accessible by the user, may be recovered. The type of delete may be selectable by a system administrator or automatically selected depending upon whether any other types of information have been associated with the group. Permanent delete may be the default, for example, after confirmation of a delete by a server user.

The delete group and other functions may be accessible through group selection as described above, menus displayed responsive to a right mouse-button click, keyboard shortcuts, or other function selection mechanisms. The invention is in no way restricted to any particular scheme for invoking such functions. Therefore, references to functions being invoked by selection of a menu option or an information record or a portion thereof should be interpreted accordingly, as illustrative examples of possible function access mechanisms.

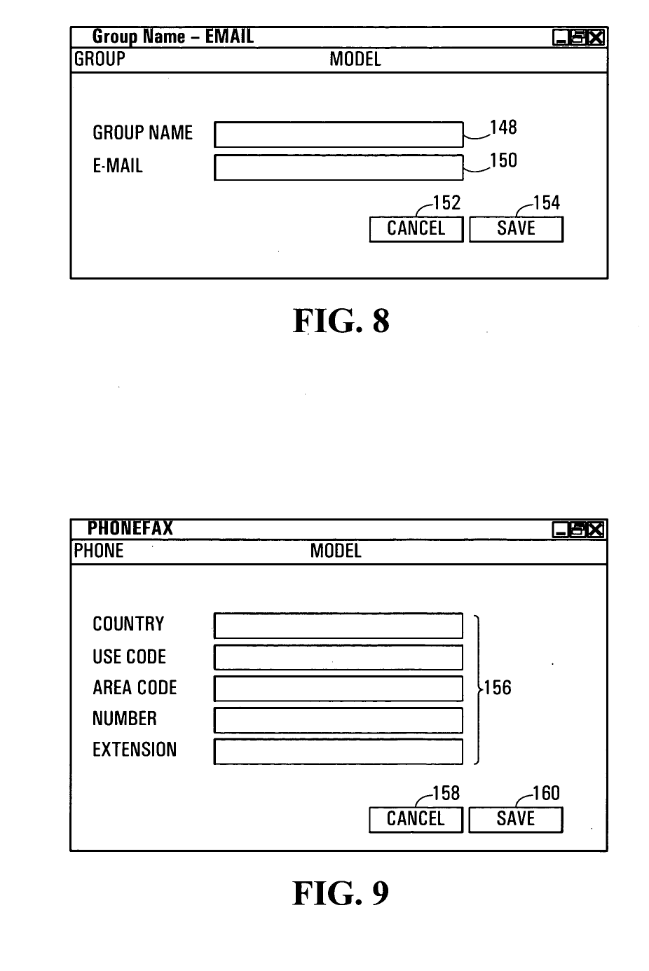

Selection of a group name preferably causes the display of a group name edit or entry GUI, an example of which is shown in FIG. 8. To change or enter a group name, the new name is entered in the group name field 148. An e-mail address of the group contact person or entity may also be entered or edited by typing an e-mail address in the e-mail field 150. Entries are cancelled or saved by operating the buttons 152, 154. For information edit operations, cancelling data entries effectively reverts to previous or stored field values.

As will become apparent from the following description, GUIs in accordance with embodiments of the invention may provide graphical elements which define user input areas or fields within which user inputs are detected. User input areas or fields may include data input areas or fields such as 148, 150, and control input areas or fields such as 152, 154 associated with control graphical elements.

Selecting a group number allows group telephone and fax contact numbers to be entered. FIG. 9 shows an example group telephone number GUI, including a graphical element 156 defining data entry fields and control graphical elements 158, 160. In FIG. 9, the “Country” data entry field provides a pulldown menu for selection instead of manual entry of data. Other data entry fields, in the GUI of FIG. 9 or other GUIs described herein, may similarly provide for data selection. The control graphical elements 158, 160 respectively allow entries to be cancelled or saved.

Some of the data to be entered in the GUI of FIG. 9, and other GUIs, may be designated as mandatory. Failure to enter mandatory data may result in error processing, to display an error message when a data save operation is invoked, for example.

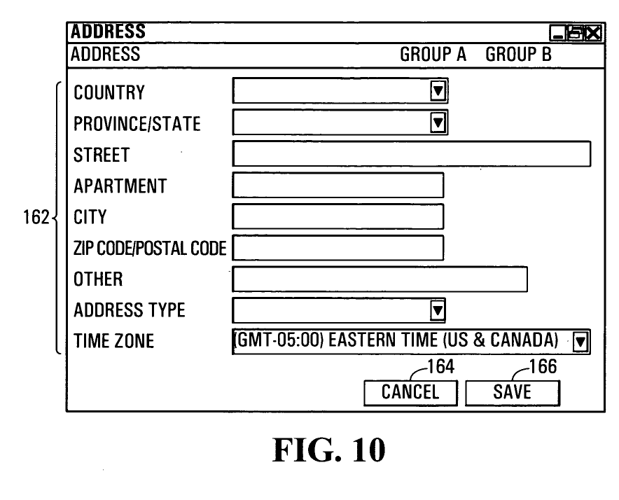

In a similar manner, a group street and/or mailing address may be entered or edited by selecting a group address field, which may cause an address entry GUI such as shown in FIG. 10 to be displayed. Data entered into the fields 162 may be cancelled or saved using the control graphical elements 164, 166. Country, province/state, and address type (e.g., home or business) are selectable fields in the GUI of FIG. 10. The “other” field shown in FIG. 10 represents one means of providing for dynamic data fields, and may be used to record address-related information which might not be used for all groups or in every embodiment of the invention.

It should be appreciated that the above group information and fields are intended for illustrative purposes. Further, fewer, or different fields may be provided and populated in a database.

When a new group is created, it might not be activated for use until a group administrator has been created to administer the group. The initial group administrator for any group can preferably only be created by the system administrator.

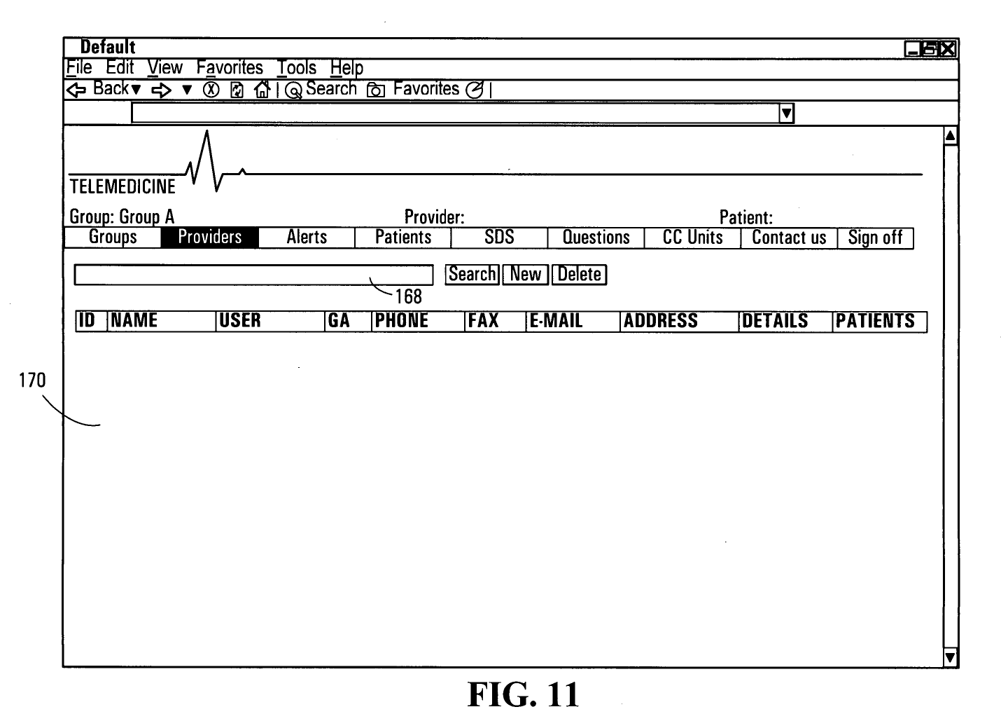

In one embodiment, to create the group administrator, the system administrator first selects a group in the system administrator GUI and then selects the provider tab, which causes a blank care provider information management GUI to be displayed. FIG. 11 shows an example of a blank care provider information management GUI, which includes a new care provider definition graphical element 168 and a care provider display graphical element 170. In FIG. 10, no care providers have been created for the group, and as such, the element 170 is blank.

To create the group administrator entry, a care provider name is entered at 168. Operation of the “New” button creates a new care provider entry in the database, and a new care provider entry is displayed at 170. A group administrator is substantially the same as a care provider, described in further detail below, but has additional permissions and capabilities.

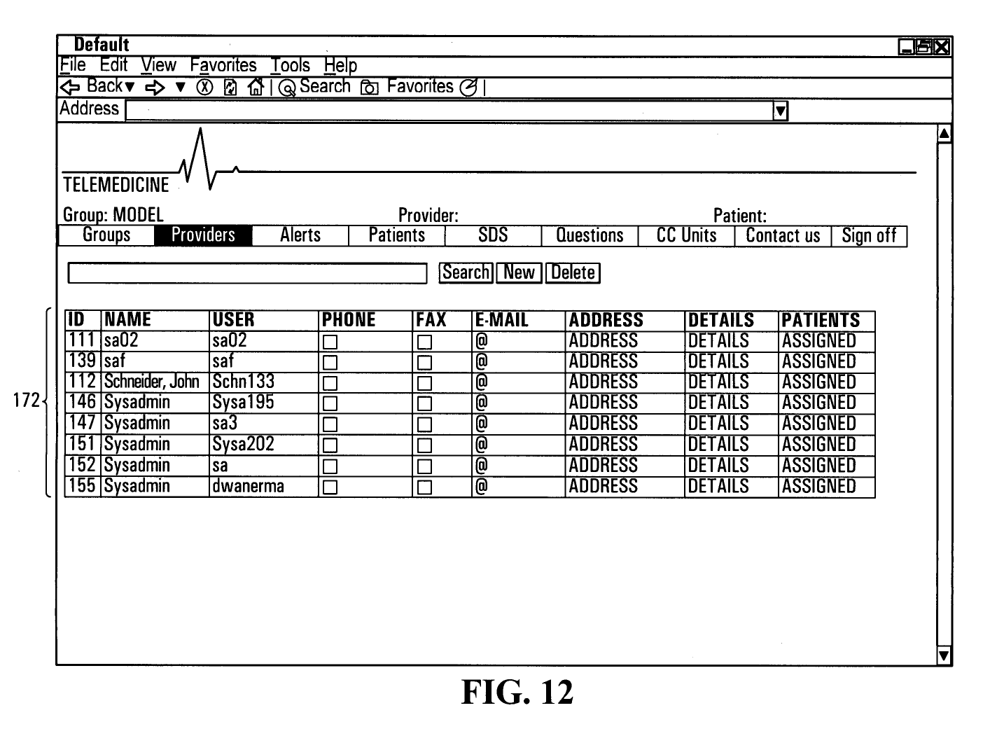

After care providers have been created in a group, the care provider information management GUI of FIG. 11 would appear as shown in FIG. 12, wherein a list of care providers for a selected group is displayed at 172.

In one embodiment of the invention, all system administrators are associated as care providers with a particular master group. The selection of the master group and subsequent selection of the providers tab then lists all system administrators. System administrators may then be added, edited, or deleted in substantially the same manner as other care providers.

The patient systems installed in patients'homes are preferably programmed with unique serial numbers for identification when they communicate with the server. Numeric identification may be preferred to avoid using patient names in external communications for security or confidentiality reasons, for instance. The system administrator may be responsible for maintaining a list of patient systems assigned to each health care group. The health care groups then assign patient systems from these lists to their patients.

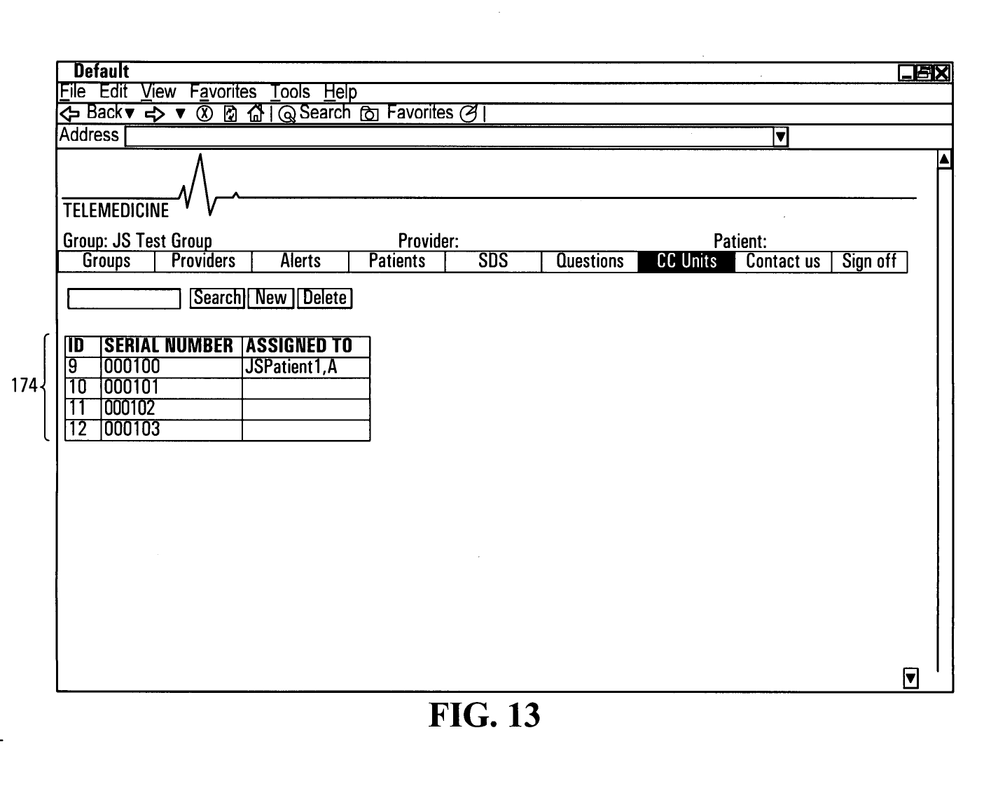

To create an equipment list for a group from the group information management GUI of FIG. 7, for example, a group and then a patient system tab, labelled “CC Units” in FIG. 7, are selected. This causes a patient system management GUI, an example of which is shown in FIG. 13, to be displayed.

In FIG. 13, the graphical element 174 includes a table with two columns. The first column is the list of all patient system serial numbers assigned to the selected group, and the second column contains the name of the patient to whom the system is assigned. The second column is blank unless the unit is assigned to a patient. Patient system assignment is described in further detail below.

To add a new serial number, the number may be entered in user input areas defined by further graphical elements above the graphical element 174 in FIG. 13. An entered new serial number record is added to the list by operating a control graphical element such as the “New” button.

To delete a serial number, the ID of the serial number in the list and then the “Delete” button may be selected. A serial number preferably cannot be deleted if it is assigned to a patient.

As will be apparent from the foregoing, a serial number may be edited by selecting the serial number, which causes a GUI, such as a pop-up window, to be displayed. A serial number entry or edit GUI, like those in the preceding Figures, may include control graphical elements for cancelling or saving serial number entries. Patient unit serial numbers are preferably unique across all of the groups associated with the same database.

The GUI of FIG. 13 also provides a search function to locate a record for a particular patient system.

The group administrator is the person or persons designated to manage and administer group activities. A group administrator manages care provider information by creating and editing entries in the database for the care providers associated with the group. Patient information may also be managed by a group administrator by creating and editing personal information profiles in the database for the patients associated with the group. The group administrator may also assign patients to specific health care providers responsible for their care.

Assignment and re-assignment of patient systems to patients within the group is a further group administrator function, as is managing standardized data sets. Standardized data sets form a library of health management protocols used by the group. A group administrator is authorized to create and edit these protocols. Other health information, such as lists of allergy, diagnosis and medication codes used by the group may also be managed by the group administrator.

The group administrator is registered in the system as a care provider with special privileges, and is preferably permitted to also perform all of the functions associated with the care provider user type. The system administrator will have performed all of the necessary activities such as creating groups, creating group administrators and assigning patient systems to the groups for deployment, as described above.

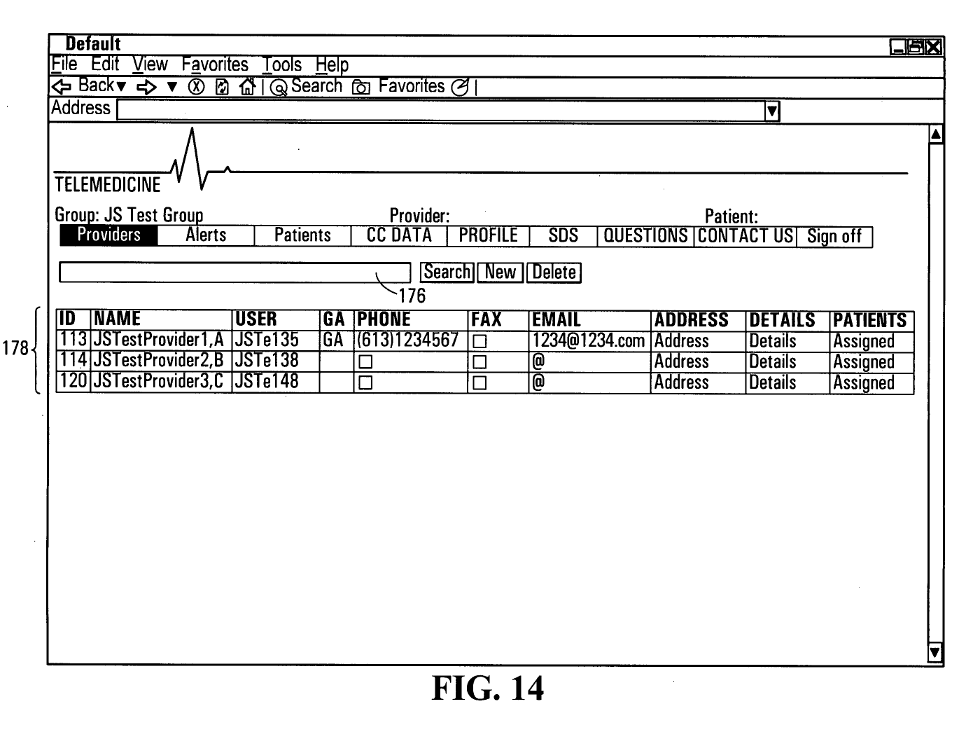

When the group administrator logs into a server account, a care providers management GUI such as shown in FIG. 14 is preferably displayed. This GUI lists all of the care providers associated with the group at 178. The care providers are the health care professionals, physicians, nurses, etc., responsible for patient care. Using this GUI, the group administrator can manage care providers by creating new care providers, editing existing care provider information, and deleting care providers, in substantially the same manner as a system administrator manages groups.

The GUI of FIG. 14 shows a list of all the care providers associated with the group, in alphabetical order. In one embodiment, the care provider list may be filtered by typing one or more letters in the data entry field at 176 and then clicking the “Search” button, for example. This causes only care providers with names starting with those letters to be displayed. To display all care providers again, the search button may be operated with the data entry field cleared.

To perform any function with a care provider, the provider is first selected, such as by clicking on the ID field associated the care provider.

The name of a selected care provider is preferably displayed in the situational reference field above the function tabs. A blank field indicates that no care provider is currently selected. Since a care provider is associated with a particular group, the name of the group is preferably displayed in all GUIs accessible through a care provider account.

Selecting an editable care provider field selects the provider and causes a field-specific data entry GUI, illustratively a pop-up dialog, to be displayed. The data entry GUI allows data to be edited or entered into the fields.

The list entry for each care provider in a care provider management GUI provides basic information related to that care provider. The ID, name, phone, fax, e-mail, and address fields are substantially similar to the corresponding group fields described above, except that these fields are now associated with a particular care provider instead of a group contact.

A care provider username assigned to a care provider is the username used to log into the server. This field and sub-fields can be edited by the group administrator and possibly the system administrator, but preferably not the care provider.

The GA field displays either “GA” or is blank. GA indicates that the care provider is also a group administrator. This designation can preferably be changed to re-assign group administration privileges.

The details field provides a link to a data entry GUI through which detailed care provider information fields, described below, may be populated.

Through the patients field, a data entry GUI which allows the assignment of patients to the care provider is accessible.

To create a new care provider, a care provider name is entered in the data entry field provided in the graphical element 176. Upon operation of the “New” button, a new provider entry appears in the care provider list at 178. Completion of a new care provider profile is accomplished by populating care provider information as described in detail below.

Care providers and associated information may also be deleted by selecting a care provider and clicking on a “Delete” button or analogous graphical element. The care provider is the removed from the care provider list, possibly after confirmation of the delete operation. As described above for group deletion, care provider deletion may be permanent or temporary, depending upon whether any patient information has been associated with a care provider, for example.

To edit the fields associated with a care provider, including a new care provider, the care provider fields may be selected. Selection of a care provider field preferably causes a corresponding data entry GUI to be displayed.

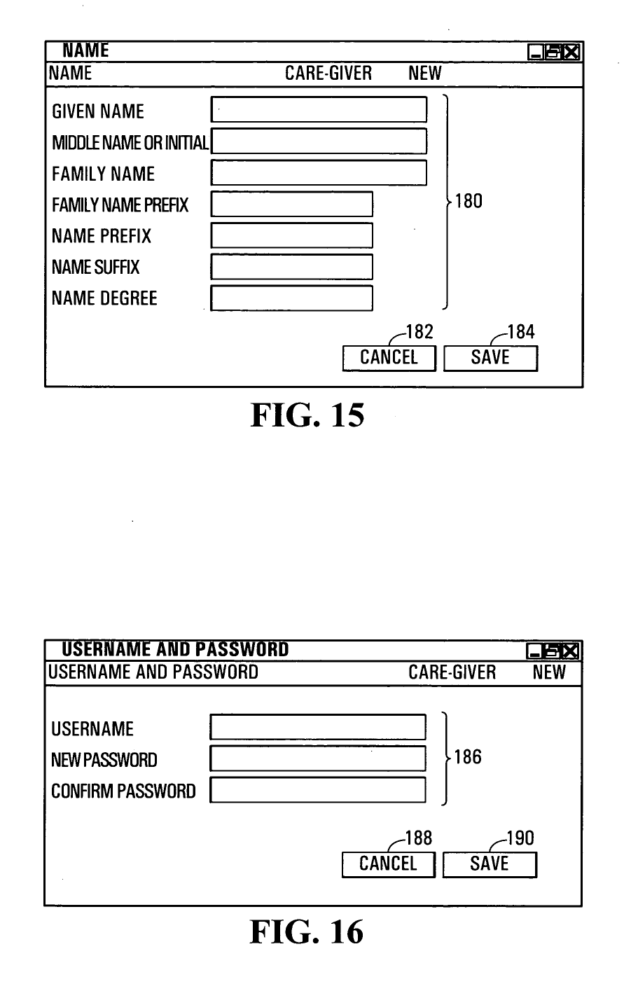

The example care provider name entry GUI of FIG. 15 may be displayed by clicking on the name field in a care provider list. This GUI defines data entry and control graphical elements 180, 182, 184, which allow the full name of a care provider to be entered. The intended content of the various data entry fields in FIG. 15 will be apparent from the labels shown.

Clicking on the user field allows a username and password for a care provider account to be established or changed, through the GUI of FIG. 16 for example. This GUI provides data entry and control graphical elements 186, 188, 190.

GUIs substantially similar to those in FIGS. 9 and 10 may be displayed by clicking on the phone or fax and address fields, respectively, in a care provider list entry. These GUIs provide for entry or editing of telephone, fax and address information for the care provider.

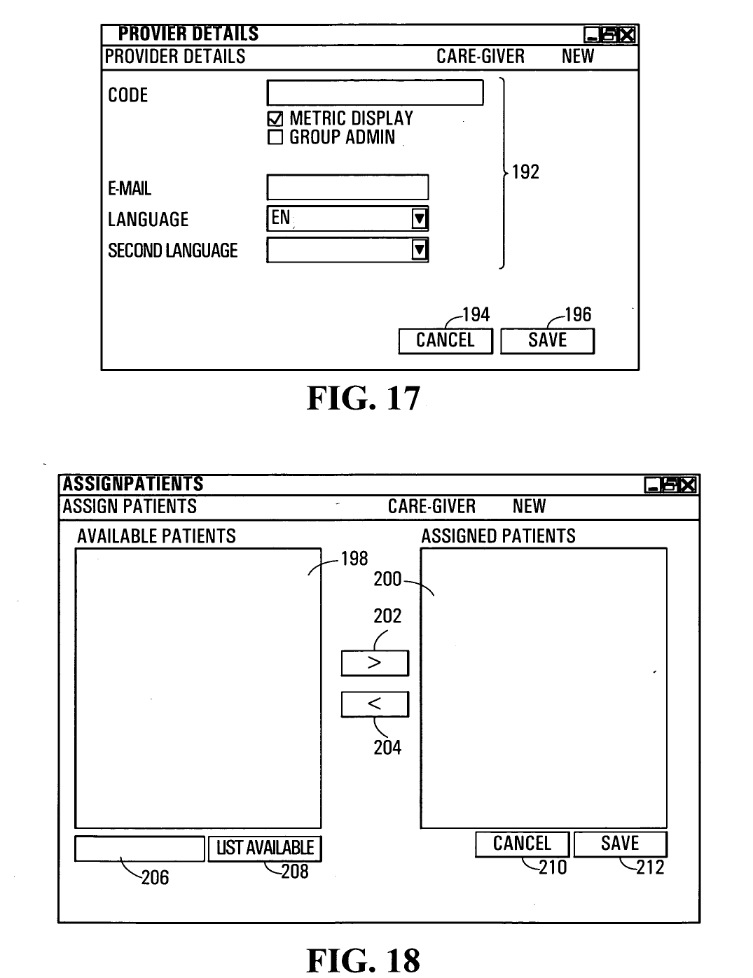

An example care provider details entry GUI, including data entry and control graphical elements 192, 194, 196, is shown in FIG. 17. This GUI includes data entry fields for GA assignment, e-mail and other care provider details and is thus preferably displayed by clicking on the GA, e-mail or details field in a care provider list.

The code entry field might be used, for example, to classify or sort care providers. The metric display check box allows selection of metric units for displayed information. Setting the GA check box designates the selected care provider as a group administrator. Although the example care provider details entry GUI of FIG. 17 assumes other than metric as default units, metric may be the default in other embodiments. Similarly, a pulldown menu or more than one check box may be provided to support selection between several units of measurement.

The language field is used to select the care provider's preferred language. This selects the language in which GUIs and user definable data such as allergy lists, medication lists, diagnosis lists, and health status questions are displayed when the care provider logs into a server account. The second language field may provide an indication of whether the care provider speaks a second language, and if so, the second language.

Patients for whom patient records have been created may be assigned to a care provider. A patient assignment GUI such as shown in FIG. 18 may be displayed by clicking on the assigned field for a care provider in a care provider list. Although the description below relates primarily to assignment of a patient to a single care provider, it should be appreciated that a patient may be assigned to multiple care providers.

The GUI of FIG. 18 includes two columns 198, 200. The column 198 is used to display all of the patients associated with the group, and the column 200 displays all of the patients assigned to the selected care provider. All of the patients in the group may be displayed using the control graphical element 208 with the data entry field 206 cleared. To filter the list, one or more letters of a patient name may be entered into the data entry field 206. For example, only those patients whose last name begins with the entered letters might be displayed in the column 198. Other filter or sort orders, based on first names or other patient information for instance, are also possible.

Patient assignments are controlled by the control graphical elements 202, 204. To assign patients to the care provider, entries for the patients in the column 198 may be selected, one at a time or concurrently, and then added to the assigned patient list in the column 200 by clicking on the ‘>’ button graphical element 202. The selected patients then appear in the column 200 and are removed from the column 198. Patient entries may be dragged and dropped between lists in another embodiment of the invention.

Removal of patients from a care provider's assigned patient list may be accomplished in a substantially similar manner, using the graphical element 204.

The control graphical elements 210 and 212 allow patient assignments to be cancelled or saved.

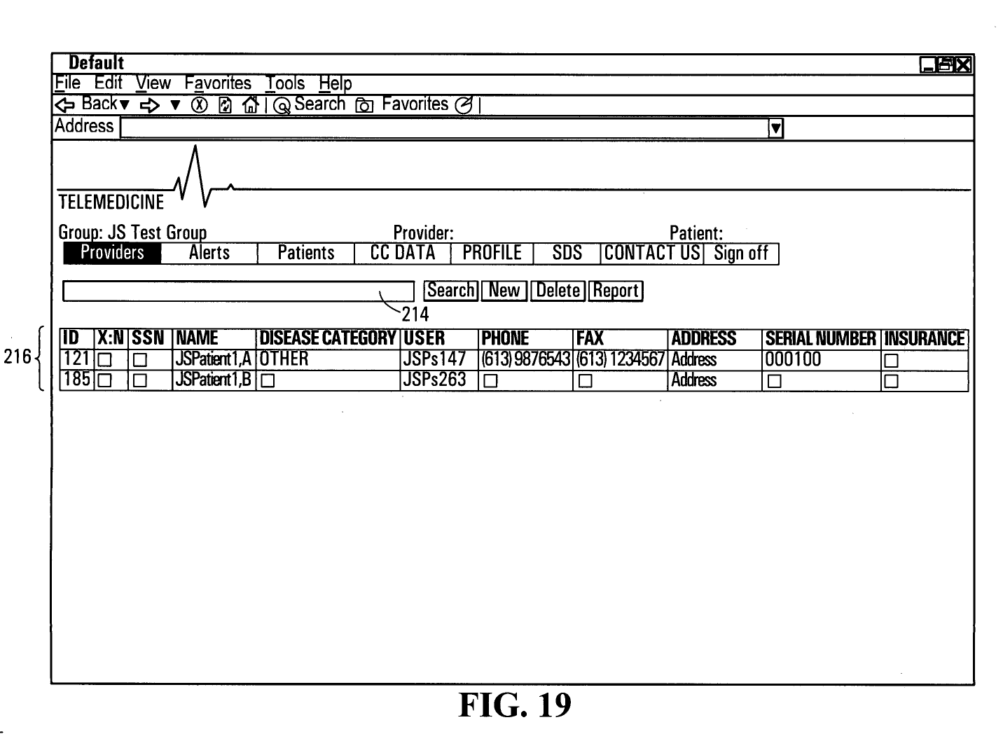

The patients assigned to a care provider can then be viewed by selecting the provider in the care provider management GUI of FIG. 14 and clicking on the patients tab. This displays a detailed list of patients assigned to the selected care provider, in a GUI such as shown in FIG. 19.

The patient information management GUI of FIG. 19 also provides for the addition of new patients, editing of patient information, and deletion of patient information. The GUI of FIG. 19 includes a list of all the patients assigned to the selected care provider at 216, in alphabetical or some other order. The patient list may be filtered as described above for care providers by typing one or more letters in the data entry field in the graphical element 214.

To perform a function with a particular patient record, the entry for the patient record in the patient list is first selected, such as by clicking on the ID field of the patient entry. The name of the selected patient is then displayed in the corresponding situational reference field. A blank field indicates that no patient is currently selected.

Each entry in a patient list displays basic information related to that patient. The ID, name, user, phone, fax, e-mail, and address fields include substantially the same information as similarly labelled fields described above for care providers. The ICN includes an Integration Control Number, which is a patient identifier used primarily by the Veteran's Administration in the United States. The SSN field includes the patient's Social Security Number (US) or Social Insurance Number (Canada). These fields might not be used, or may include different information, in other embodiments of the invention. Disease category indicates a primary disease category to which the patient belongs, and may include, for example, Chronic Heart Failure (CHF), Chronic Obstructive Pulmonary Disease (COPD), Diabetes Mellitus (DM), Hypertension, Major Depressive Disorder (MDD), and possibly other categories. The serial number field contains the serial number of the patient system assigned to the patient. The patient's primary health care insurance number is included in the insurance field.

Clicking on an editable field selects the patient record and causes a field-specific GUI, such as a pop-up dialog, to be displayed, allowing data to be edited or entered into the fields.

To create a new patient record, a patient name is entered into the data entry field provided in the graphical element 214. An entry for the new patient record appears in the patient list at 216 when the “New” button is operated or a user input is provided within an input area defined by an analogous graphical element. Patient records may be deleted by selecting a patient and clicking on the “Delete” button. Patient record deletion may be permanent or temporary, depending upon whether any medical information was associated with the patient record at the time when it was deleted, for example.

As above, patient record field editing may be accomplished by selecting fields for the patient record in a patient list entry.

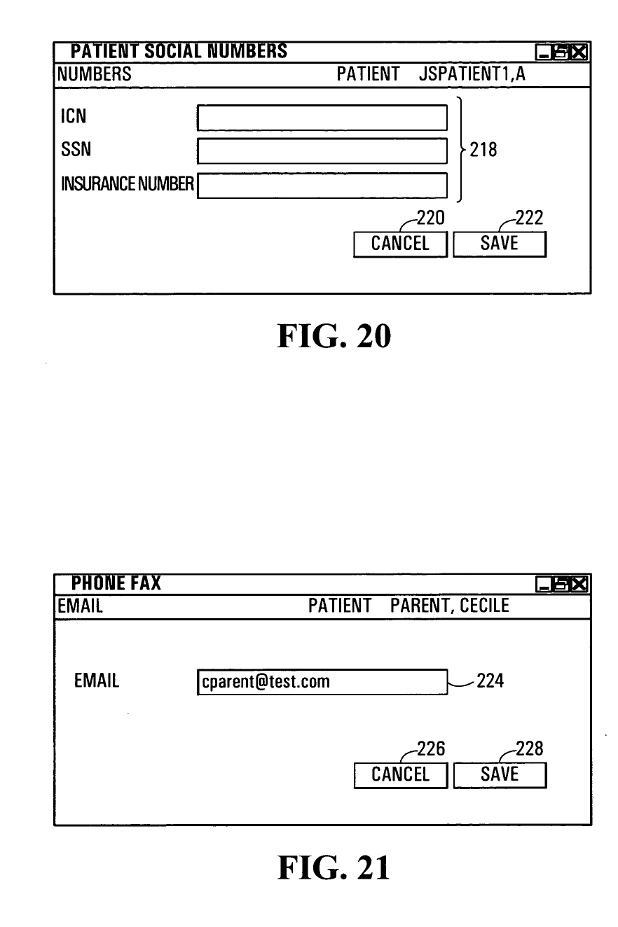

In one embodiment, ICN, SSN, and insurance fields are associated with the same data entry GUI, such as the GUI shown in FIG. 20. Clicking on either of these fields then causes the same data entry GUI to be displayed. The example GUI of FIG. 20, like other data entry GUIs described above, includes data entry and control graphical elements 218, 220, 222.

Example name, user, telephone and fax number, and address data entry GUIs have been described above, and substantially similar GUIs may be used to populate these fields in a patient record. A time zone setting in an address field may be particularly useful for a server which services patients in different time zones. The server may thereby make time adjustments for actions or reminders, described in further detail below, where necessary.

FIG. 21 shows an example patient e-mail entry GUI, including an e-mail data entry graphical element 224 and control graphical elements 226, 228.

Each patient system is programmed with a unique serial number for identification of the system when it communicates with the server. The serial number of the patient system is thus preferably recorded in the patient's record before the patient uses the patient system. The serial numbers are assigned, for example, from a pool of patient system serial numbers assigned to groups by the system administrator, as described above.

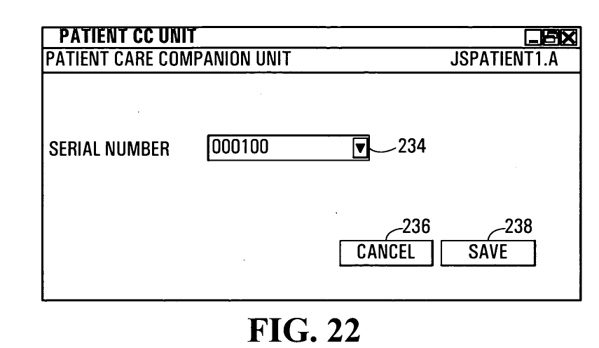

The serial number may be recorded in the patient record by selecting the serial number field in an entry in a care provider patient list. FIG. 22 is an example patient system assignment GUI which may be displayed upon selection of the serial number field.

A pulldown menu as shown at 234 facilitates selection of a serial number of a patient system. The control graphical elements 236, 238 allow a patient system assignment and serial number to be cancelled or saved. The list in the menu 234 contains only those serial numbers available to the group and not already assigned to other patients, and thus limit the likelihood of a duplicate assignment or incorrect serial number entry.

The GUI of FIG. 22 also provides for removal of a serial number assignment from a patient record for reassignment to another patient, by selecting a blank serial number entry in the serial number list 234 and clicking the Save button 238.

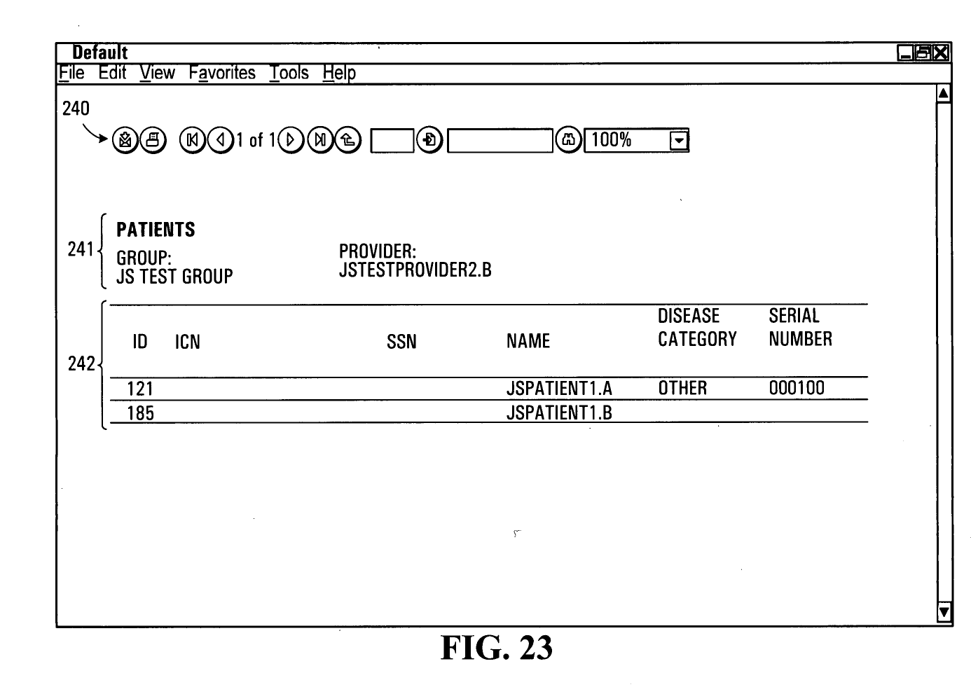

The report button in the graphical element 214 of FIG. 19 allows a report listing all of the patients assigned to a selected care provider to be generated. A GUI such as shown in FIG. 23, including control graphical elements 240 in a report control toolbar, a graphical element 241 including patient group and care provider information, and a graphical element 242 including a patient list, may be displayed. This report may be printed or saved to a file. Report controls in the toolbar 240 are described in further detail below.

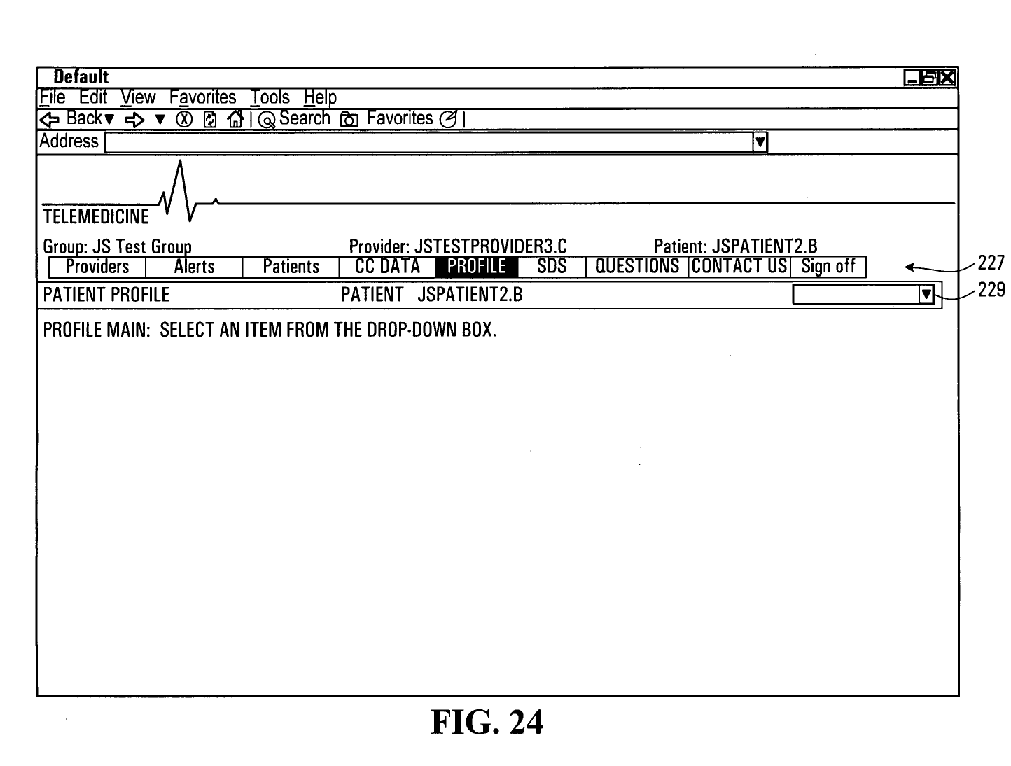

Patient profile information may be entered for the patient by clicking the profile tab, which displays a patient profile management GUI such as shown in FIG. 24. The selected group, care provider, and patient are indicated at 227. Different information in the patient profile may be entered by selecting an option from the pulldown menu 229.

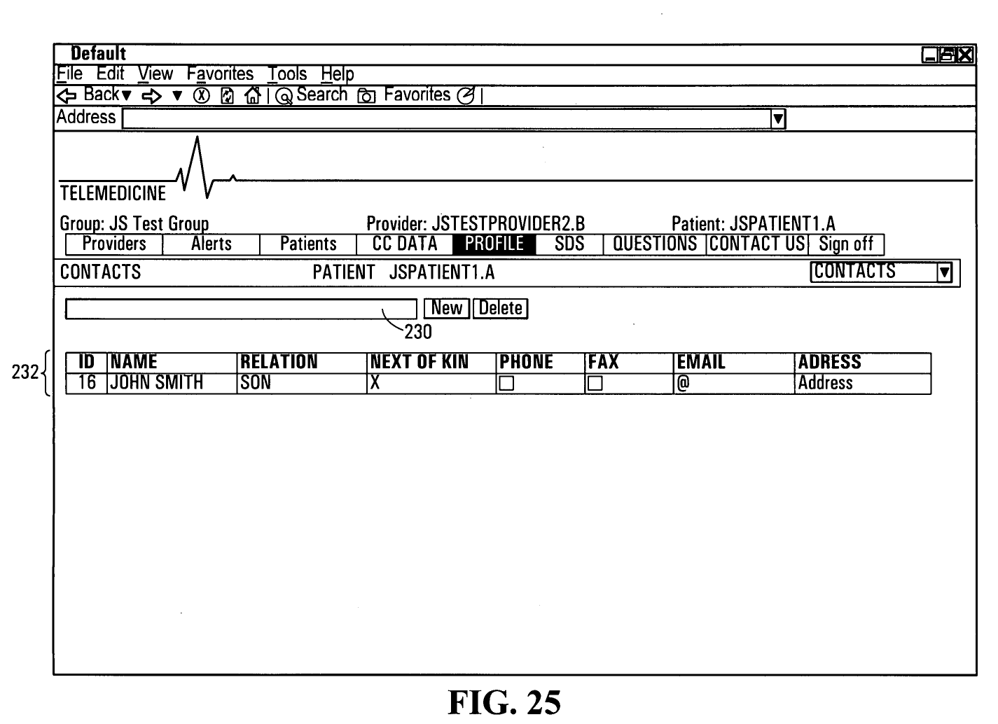

Selection of a contacts option in the pulldown menu 229 causes a patient contact information management GUI to displayed. FIG. 25 shows an example of such a GUI. A data entry field and control graphical elements are provided at 230, and a list of contacts is provided at 232. The labelled fields show information for each contact.

The ID is preferably a unique ID assigned when the contact record is created, and, as above, can be used for record selection. The name, phone, fax, e-mail, and address fields are substantially as described above. The relation field indicates the relationship of the contact to the patient, and the next of kin field indicates whether the contact is a next of kin to the patient. Each of these fields, except the ID field in a preferred embodiment, can be edited substantially as described above.

New contacts may be added by typing the name of the contact in the field provided at 230 and clicking the “New” button. A new record is created and displayed for the contact at 232. To delete a contact, the contact entry in the contacts list may be selected, by clicking on the ID field, for example, and then clicking the delete button.

Additional patient information such as any allergies that the patient has, any medications that the patient is taking, and any conditions or illnesses that the patient suffers from may be added to the patient profile. The functions supporting this data entry are selectable using the pulldown menu 229 (FIG. 24).

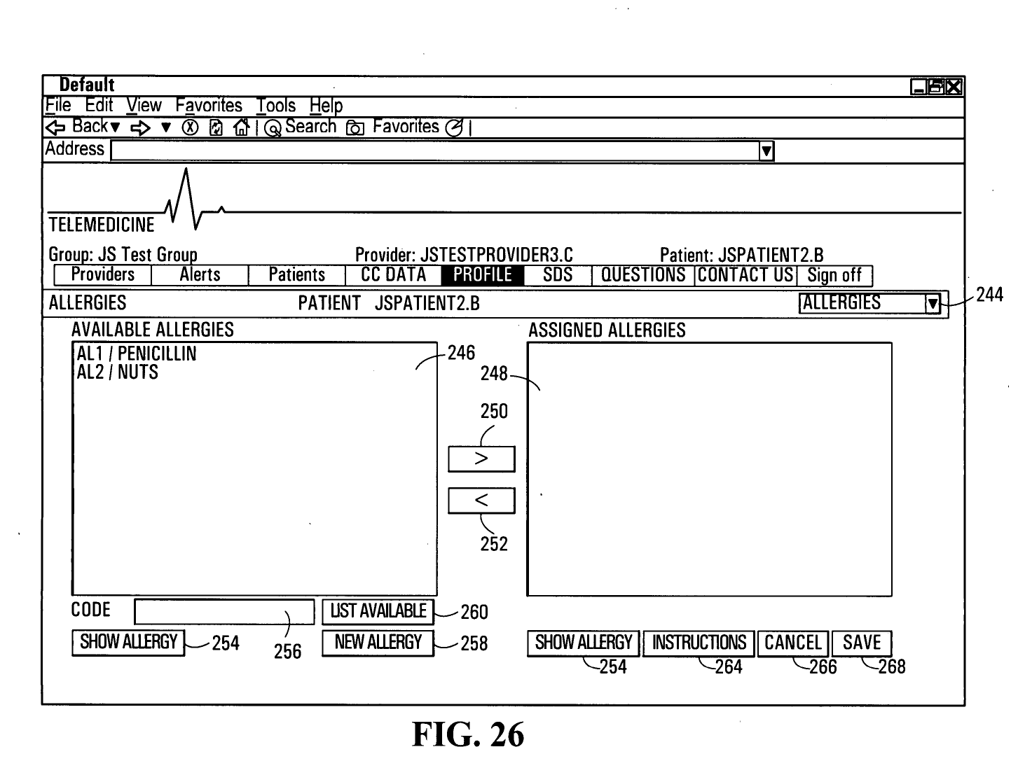

To edit a patient allergy list, an Allergies option is selected from the pulldown menu 229 of the patient profile management GUI. An example of a patient allergies management GUI is shown in FIG. 26, in which selection of the Allergies option is shown at 244. This GUI includes graphical elements 246, 248 for displaying allergies, a data entry field 256 for filtering an allergy list, and various control graphical elements 250, 252, 254, 258, 260, 262, 264, 266, 268.

The GUI of FIG. 26 includes two columns 246, 248, respectively used to display all of the allergy codes and names used by the group and those associated with the selected patient. The data entry field 256 and the control graphical element 260 may be used to filter the list according to one or more characters of an allergy or code.

Selection of allergies and adding allergies to a patient record using the control graphical elements 250, 252, 266, 268 is substantially as described above with reference to patient assignments and FIG. 18.

If the patient suffers from an allergy not contained in the list at 246, the unlisted allergies may be added using the control graphical element 258, as described in further detail below.

The show allergy control graphical elements 254, 262 allow further information associated with a selected allergy to be displayed. Instructions, for allergy relief or treatment, for example, may also be displayed using the control graphical element 264. These control graphical elements may also allow editing of allergies.

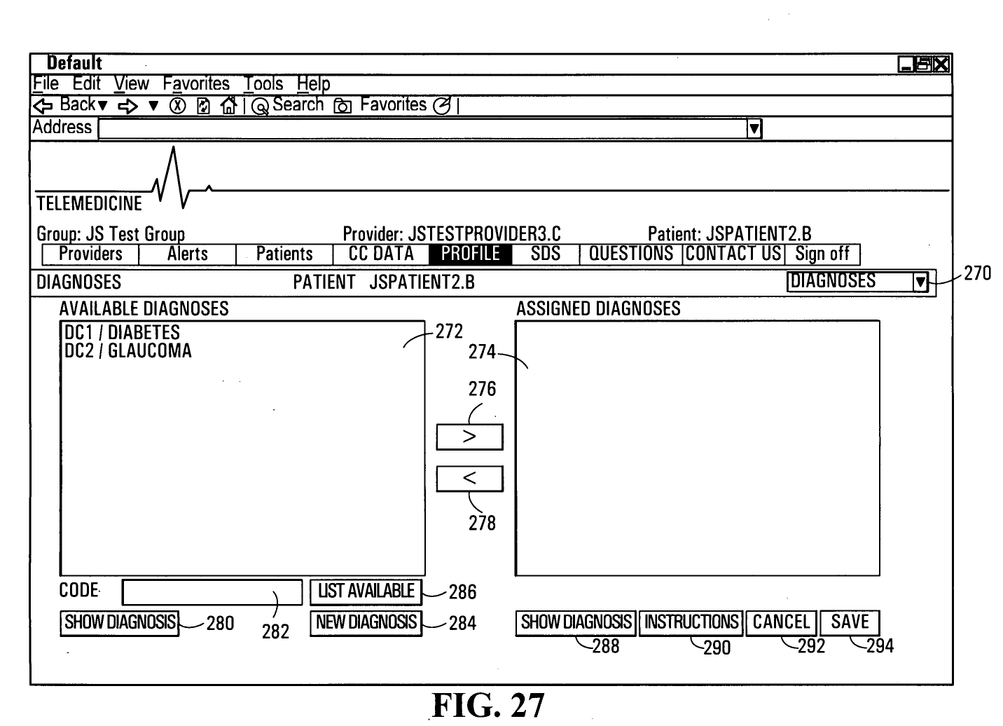

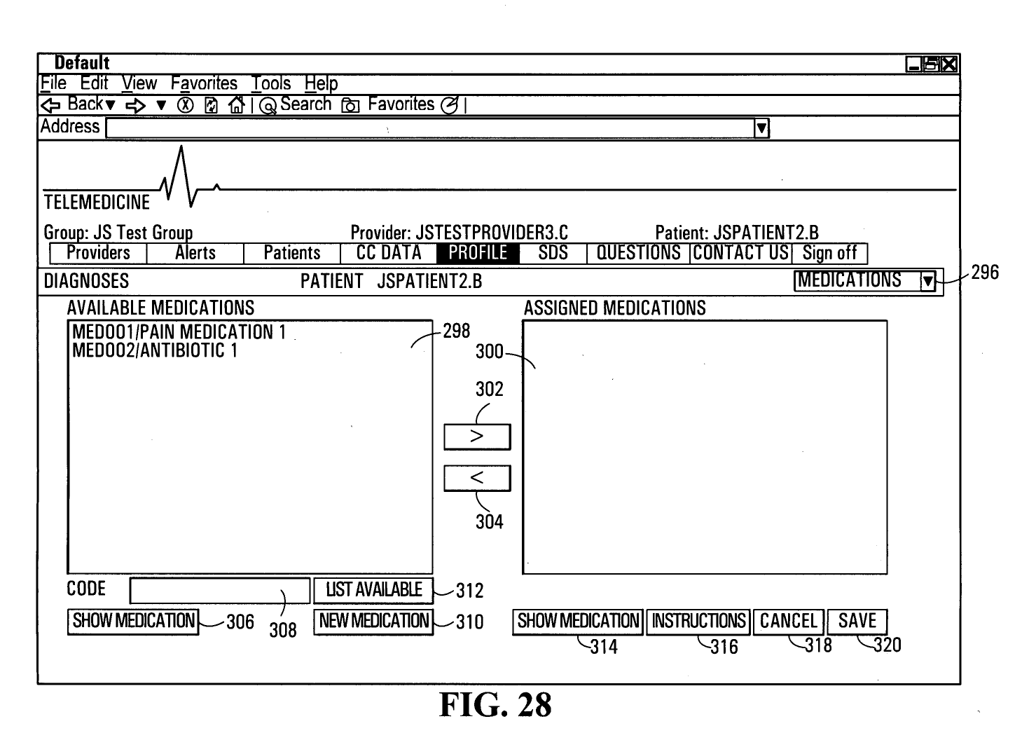

FIGS. 27 and 28 show example patient diagnoses and medications management GUIs, respectively, which may be displayed by selecting Diagnoses and Medications options in the pulldown menu in a patient profile management GUI, as shown at 270 and 296. These GUIs provide display and control graphical interfaces 272-294 (FIG. 27) and 298-320 (FIG. 28) using which diagnoses and medications may be added to a patient profile, substantially as described above.

The GUIs of FIGS. 26-28 include references to allergy, medication, and diagnosis codes. In one embodiment, multiple coding conventions for allergies, medications, and diagnoses are supported. It is therefore possible to record the same allergy, medication, or diagnosis names under several coding conventions for subsequent access under any of these coding conventions.

Multiple languages are also supported in another embodiment, such that the same allergy, medication, or diagnosis may be stored and accessible in more than one language. If it is the operating policy of a health care group to use multiple languages, then entries made to the allergy, medication, and diagnosis lists are preferably translated into each of the supported languages.

To add or edit allergies, the Allergies option is selected from the patient profile management GUI, as described above. The patient allergies management GUI (FIG. 26) is then displayed.

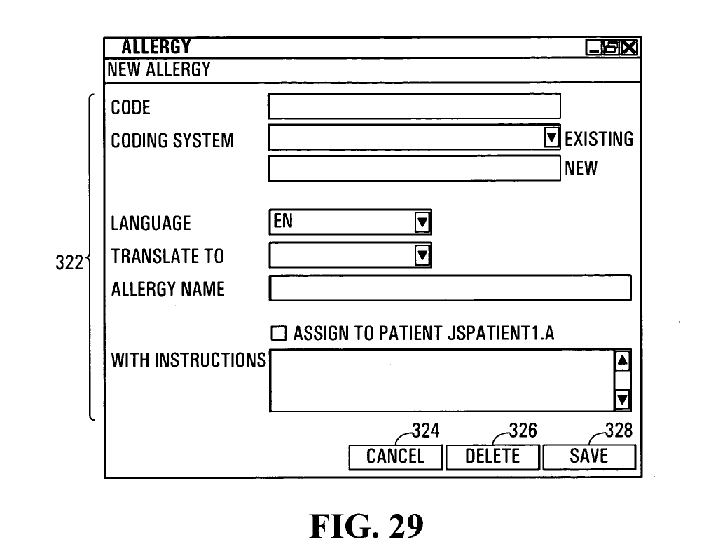

The control graphical element 258 is used to add a new allergy, and causes a new allergy entry GUI to be displayed. An example new allergy entry GUI is shown in FIG. 29. The GUI of FIG. 29 provides a data entry graphical element 322 defining data input areas and control graphical elements 324, 326, 328.

In the code data entry field, a code used to uniquely identify the allergy, according to a coding system selected from a pulldown menu in the example GUI, is entered. If a preferred coding system does not exist in the list provided, then the name of the coding system may be entered in the new coding system field. If the group uses only one coding system, then this field and the pulldown menu might not be used.

The language data entry field provides for selection of the language in which the allergy name is being entered. The translate to field, on the other hand, provides for selection of another language in which the allergy name, and possibly other information in an allergy record, is being entered for an existing allergy.

A name is associated with an allergy by entering a name in the allergy name data entry field.

As described above, a new allergy entry function is invoked through a patient profile management GUI in one embodiment of the invention. The assign to patient check box allows the new allergy to be automatically assigned to the currently selected patient, in addition to being added to a group allergies list.

If the new allergy is assigned to the patient, the with instructions field can be used to enter any patient-specific instructions or information concerning the allergy.

The control graphical elements 324, 328 allow a group administrator to cancel or save entered information.

Allergy information editing may be invoked and performed in a substantially similar manner using the GUI of FIG. 29 and the control graphical elements 254, 262 in the patient profile management GUI of FIG. 26. The control graphical element 326 allows an allergy to be deleted. An allergy which is assigned to any patient in a group preferably cannot be deleted.

Patient-specific information for an allergy already assigned to a patient may be added using the control graphical element 264 in the GUI of FIG. 26 and the GUI of FIG. 29 or a substantially similar GUI including only the instructions data entry field and control graphical elements.

When a new allergy is created, an entry may be made in the allergy list for each supported language. The allergy name text entered in the new allergy entry GUI is associated with the language selected in the language field of the window.

The names displayed in an available allergies list in an allergies management GUI are preferably those based on the user's preferred language indicated in a care provider profile. If the allergy name for that language has not been entered or is not available, then a blank field may be displayed next to the allergy code in the available allergies list.

Allergy names for other languages may be added by editing an allergy, using the control graphical element 254 (FIG. 26), for example. A language may then be selected from the translate to pulldown menu. An allergy name entered in the allergy name data entry field is then associated with that language when changes are saved. The translate to menu may contain a list of supported languages for which translations of the allergy name have not yet been entered. In this case, the list is empty when all translations have been made.

Automatic translation may also be provided to translate allergy names and possibly other information into other supported languages.

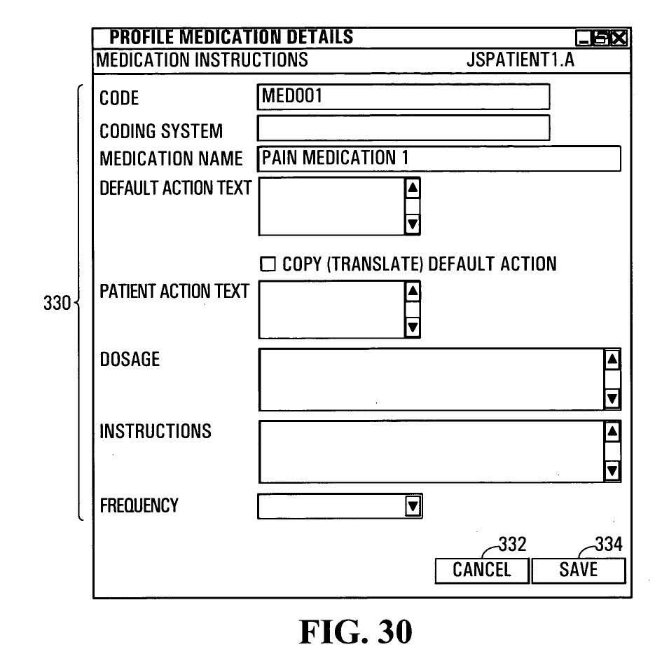

For medications, add and edit functions may be accessed through the control graphical elements 306, 310, 314, 316 in the GUI of FIG. 28. An example medication entry GUI is shown in FIG. 30, and includes a data entry graphical element 330 and control graphical elements 332, 334. The functions of the medication entry GUI are substantially similar to those described above for allergies, although some differences will be apparent.

The medication entry GUI of FIG. 30 includes a default action text entry field instead of a with instructions field. This field is related to the action/reminders function described below. The text entered in this field is a common message for any patient taking the selected medication, and can then be referenced when setting up an action/reminder event having to re-enter the text for each patient. For example, the text “Please take 2 Tylenol™ pills now.” can be entered into this field once and then referenced any time an action/reminder event is created for this medication.

The patient medication entry GUI also includes patient action text, dosage, instructions, and frequency fields. The patient action text field is used to override the contents of the default action text field. The text entered in this field becomes available for reference when setting up an action/reminder event for this patient only. This field is used if the text in the default action text field is inadequate for this patient.

As frequency of use information would normally be included in medication instructions or inherent in action/reminder scheduling, the frequency entry field might not be used in some embodiments of the invention.

The adding and editing of diagnoses is substantially as described for allergies, although a description field is preferably provided for diagnoses to provide additional descriptive information about the diagnosis. In addition, a patient-specific diagnosis description field may be provided instead of the allergies instructions field, to record any patient-specific information related to the diagnosis. Diagnosis-related functions are accessible through the control graphical elements 280, 284, 288, 290 in the GUI of FIG. 27.

The care provider management GUI of FIG. 14 also provides a Standardized Data Set (SDS) function tab. As described briefly above, an SDS is a protocol of questions or user prompts that focus on a specific disease group, health plan or treatment plan. One or more data sets can be used to create a library of Standardized Data Sets. The data sets can be built up over time and be used by health care providers in a group as references for customizing protocols of questions for their patients. The customized protocols are referred herein primarily as Health Status Data Sets, which are described in detail below.

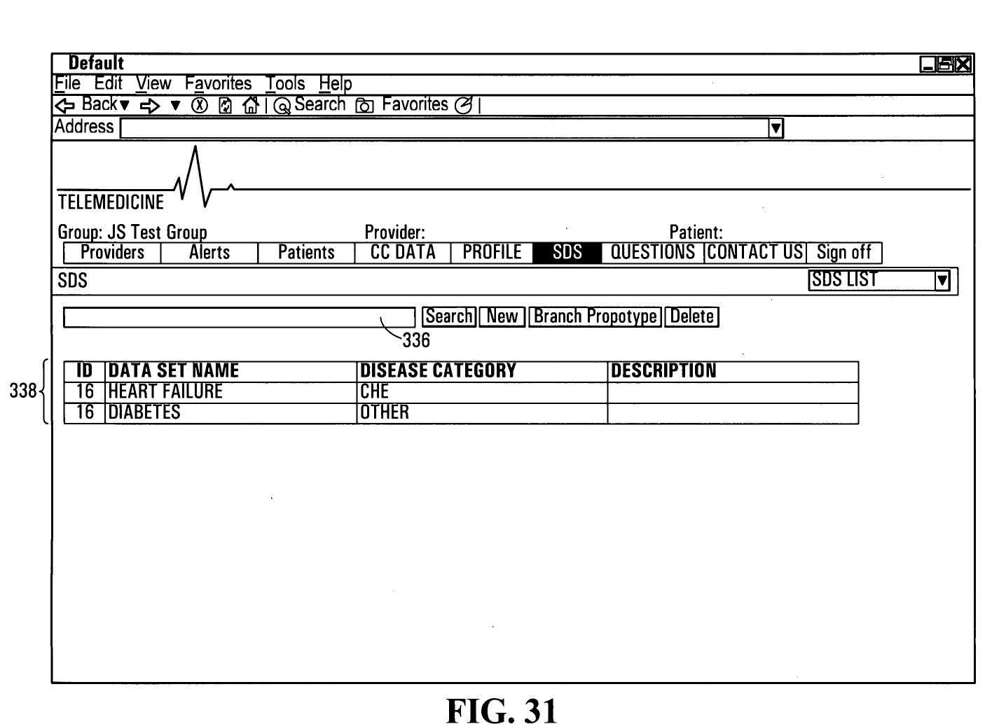

To create or edit Standardized Data Sets for a health care group, the group administrator clicks on the SDS tab to display the list of Standardized Data Sets as shown in FIG. 31, for example. A graphical user element 336 provides a data entry field and control graphical elements. A list of all the Standardized Data Sets for the selected group is provided in the graphical element 338.

The SDS list may be filtered by typing one or more letters in the data entry field and clicking the “Search” button. This causes only data sets with names starting with those letters to be displayed. To re-display all data sets, the “Search” button may be clicked with the data entry field cleared.

The data sets may be grouped into disease categories. The number and names of the disease categories are created at the discretion of the group administrator. The SDS list may then be filtered by disease category by selecting a category from the disease category pulldown menu and then clicking the “Search” button.

Each entry in the displayed SDS record list provides basic information related to that data set. ID is a unique SDS ID assigned when the SDS is created and can be used for selection of an SDS, but preferably cannot be changed. The data set name field includes the name of the SDS. Disease category is described above. A detailed description of the data set may be provided in and accessible through the description field.

To create a new SDS record, the name of the new SDS is entered in the data entry field provided in the graphical element 336. A new entry then appears in the SDS record list at 338. Deletion of an SDS record is substantially similar to deletion of other types of records as described above. A recoverable temporary deletion may be preferred, for example, if the SDS includes questions. Alternatively, the delete button might only be enabled after all questions have been deleted from an SDS.

Clicking on an editable field, which may include the data set name, disease category, and description fields, allows editing of the field through a respective GUI.

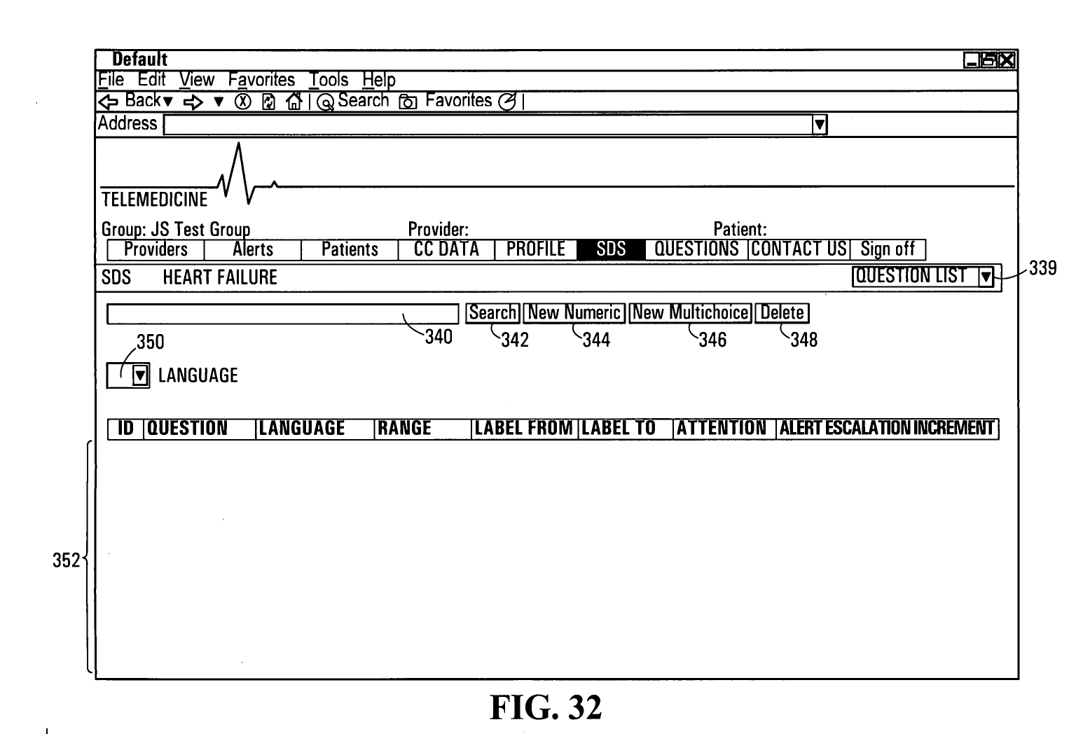

To edit an SDS itself, an SDS record entry in the configuration GUI of FIG. 31 may be selected by clicking the ID field, for example, and then selecting a questions list function. FIG. 32 shows an example of a question list configuration GUI in which a question list option is selected in a pulldown menu at 339. An SDS list or analogous option may provided in the pulldown menu to return to the GUI of FIG. 31. The GUI of FIG. 32 includes various data entry and control graphical elements 340-350 and a graphical element 352 for displaying questions in a currently selected SDS.

As indicated at 344 and 346, two types of questions can be added to an SDS through the GUI of FIG. 32: numeric response questions and multiple choice response questions. Numeric response questions are questions that expect a response within a range of numbers, for example, “How severe is your pain today, from 1 to 10?”. Multiple-choice questions are questions that expect a response selected from a list of options, such as “Have you experienced any chest pain today? No, Yes”. questions may be generally considered types of user prompts.

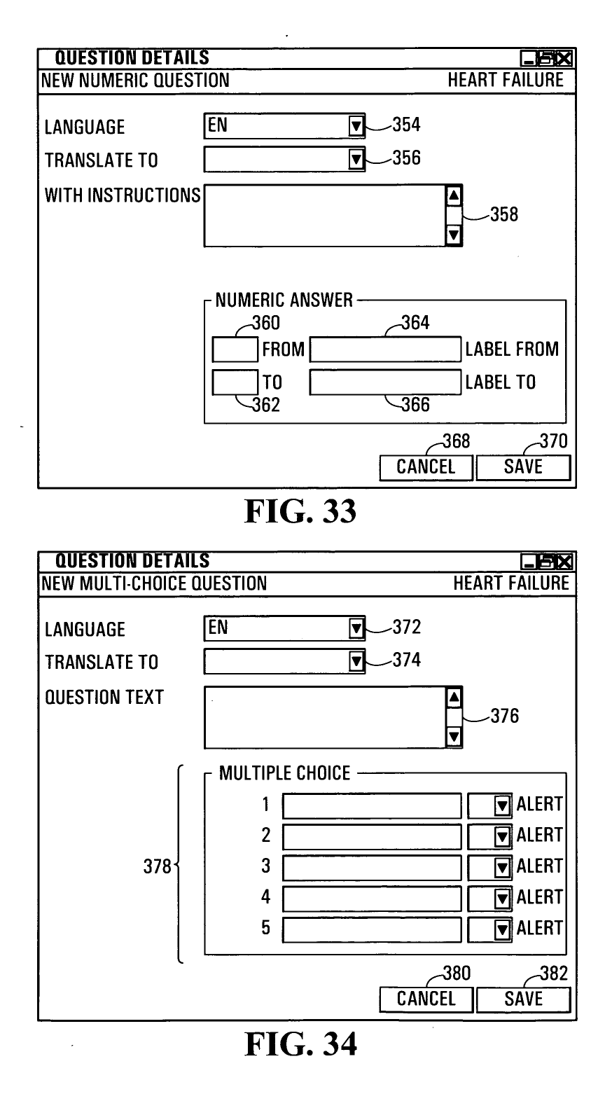

A numeric response type question may be added using the control graphical element 344, i.e., by clicking on the “New Numeric” button. This causes a new GUI, illustratively a pop up page, to be displayed, an example of which is shown in FIG. 33. Text of a question is entered in the text entry field 358. The language and translate to fields 354, 356 are used substantially as described above for allergies, diagnoses, and medications.

A number corresponding to the lowest response in a response range is entered into the From field at 360. If this number has a corresponding text equivalent, then this text may be entered at 364. Using the above example of a user prompt for a user to rate pain severity from 1 to 10 , “1” is entered in the From field 360 and “None” could be entered in the Label From field 364. Similarly, a number corresponding to the highest response in the range and a text equivalent, if any, are entered into the fields 362, 366.

Entered question information may be cancelled or saved using the control graphical elements 368, 370. Saved questions are shown in a list at 352 in the GUI of FIG. 32.

To edit an existing numeric response question, any field of the question may be selected on the SDS question page of FIG. 32. This causes the GUI of FIG. 33 to be displayed. Fields may then be edited as necessary, and changes may be cancelled or saved.

Translation of a question into another supported language may be accomplished substantially as described above, using the translate to pulldown menu at 356. The language pulldown menu 350 provides for filtering of a question list to show only the questions for one language.

A new multiple-choice response type question may be added using the New Multi Choice button at 346, which displays a new GUI such as shown in FIG. 34. The language, translate to, and question text fields 372, 374, 376 are used substantially as described above.

At 378, the text for each of the possible responses to the question is entered in the fields provided. Using the example from above, choice 1 is “No” and choice 2 is “Yes”. If an alert is to be generated when the patient selects a particular response, then an indicator, illustratively the number 1, is selected from the alert pulldown menu associated with that response. If no alert is to be generated, than a blank entry or some other entry is selected. A new multiple choice question is cancelled or saved using the control graphical elements 380, 382. When saved, a new multiple choice question is displayed at 352 in FIG. 32.

Question editing and translation for multiple choice questions is substantially as described above for numeric questions.

Where patient units support more than one language, questions and labels can be formed using any of the characters listed below. This is a list of characters that can be displayed by patient systems in one embodiment of the invention:

! “ % ‘ ( ), - . / \ (sp) < > = @ # $ & ' A B C D E F G H I J K L M N O P Q R S T U V W X Y Z a b c d e f g h i j k l m n o p q r s t u v w x y z Ä \dot{A} [symbol] β [symbol] É Ö Ü Ñ â ä à å á æ ç ê ë è é \ddot{l} \hat{l} \grave{l} ĺ ñ ô ö ò ó û ù ü ú ÿ

In this case, the patient systems support the standard characters required for non-English languages (for example, è in French or å in Swedish), which permits the presentation at a patient system be in a preferred language. It should be appreciated that other characters or character sets may also or instead be provided.

There are a variety of methods using which the questions may be entered into the system at the server. These include using a standard keyboard and codes such as ALT/XXX where XXX is a number. For instance, ALT/134 produces å. Another method is the use of a keyboard designed for a specific language, where the special characters required for that language are present as individual keys. In this case, special characters are entered directly through individual keys. Some special characters may be produced as a composite of 2 keys. Different keyboards may offer a variety of solutions for entering language special characters.

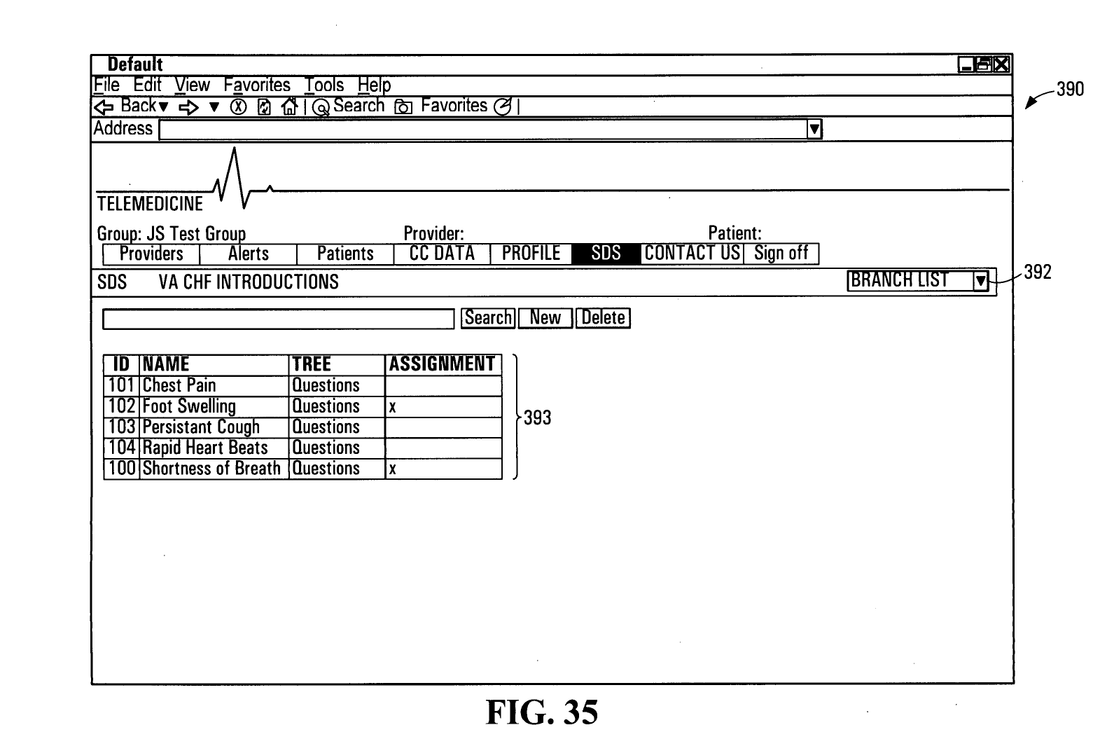

A further embodiment of the invention guides a server user through the construction of a nested or branched logic suite of user prompts that are to be presented to the patient at the patient system. Currently known patient profile configuration techniques do not provide a clear and intuitive indication of any hierarchical or dependency relationship between user prompts. Configuration of user prompts in a patient profile according to an embodiment of the invention will become apparent from the following description, with reference to FIGS. 35-38.

FIGS. 35-38 are representations of GUIs for display to a server user in accordance with embodiments of the invention. The GUIs of FIGS. 35-38 are intended solely for illustrative purposes, and as such, embodiments of the invention are in no way restricted to the particular layout, formats, sizes, or content explicitly shown therein.

FIG. 35 represents a GUI 390 through which a health care provider or server administrator selects a branched user prompt configuration function, from a pick list at 392 in the example GUI of FIG. 35. The “Branch List” entry shown in FIG. 35 may be provided in the pulldown menu 339 of the GUI shown in FIG. 32.

As will become apparent from the following description, branched user prompts have a hierarchical or nested structure. The lists displayed at 393 may be all of the lists associated with a particular patient profile, a group of patients, a particular medical condition, or a particular health care provider, for instance.

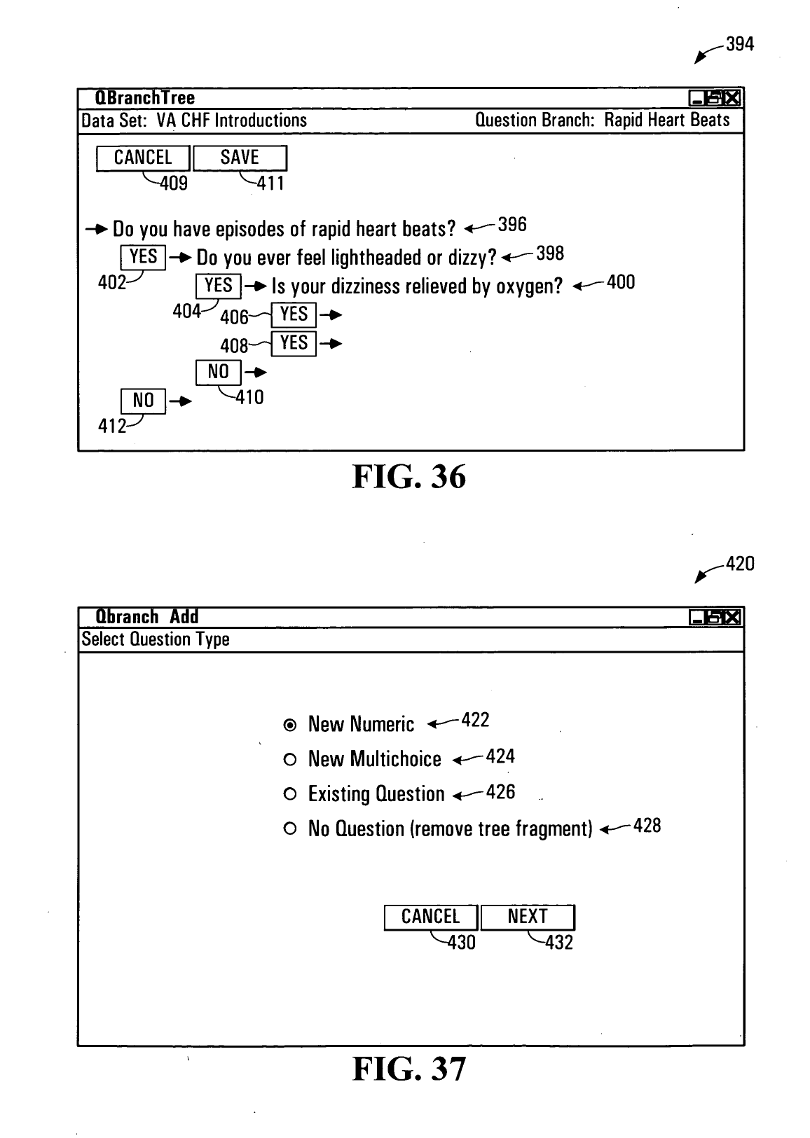

FIG. 36 is an example of a GUI 394 used in configuring user prompts, illustratively health questions, to be presented to a patient at a patient system. The GUI 394 is displayed when an existing set of user prompts is selected at 393 (FIG. 35), or when a new set of user prompts is being constructed. Respective user prompt graphical elements 396, 398, 400 include the user prompts, and response graphical elements 402, 404, 406, 408, 410, 412 include the permitted responses to each user prompt.

User prompt graphical elements for user prompts that are intended to be displayed to the patient upon a predetermined response to another user prompt, referred to primarily herein as subordinate user prompt graphical elements, are associated with the response graphical element of the predetermined response to the other user prompt. For example, the user prompt of the element 398 is dependent upon a patient response of “Yes” to the user prompt of the element 396, and is thus associated with the response graphical element 404. This association in the example GUI 394 is provided by displaying the elements 404 and 398 at adjacent locations on a display, although associations between elements may be indicated through other alternative or additional techniques, including common attributes such as color, font, size, horizontal position (i.e., indentation) on the display, and vertical position on the display, for example.

Input graphical elements defining input areas of the display are also preferably provided. In a preferred embodiment, each response graphical element is also an input element, such that selecting a response graphical element, by using a mouse cursor for instance, allows a new user prompt to be associated with that response. When an input is detected within the input area, a new user prompt graphical element is preferably displayed. Although not explicitly shown in FIG. 36, input areas may be provided to add a new base or root user prompt that is not associated with another user prompt. This function may be invoked, for example, from a menu displayed in response to a mouse button click when a mouse cursor is positioned outside any user prompt or response graphical elements in the GUI 394. The elements 409 and 411 allow a current user prompt set to be cancelled or saved.

FIG. 37 represents an example of a new user prompt graphical element, itself a GUI 420, which provides for selection of a type of user prompt. User prompt type graphical elements 422, 424, 426 respectively correspond to types of user prompts, including in this example a numeric prompt for numeric information, a multiple choice user prompt, and an existing question which is stored at the server in the memory 100 or possibly the database 92 (FIG. 3). A “No Question” element 428 allows a current branch or fragment of a user prompt set or tree to be removed. The elements 430 and 432 confirm or cancel a selection.

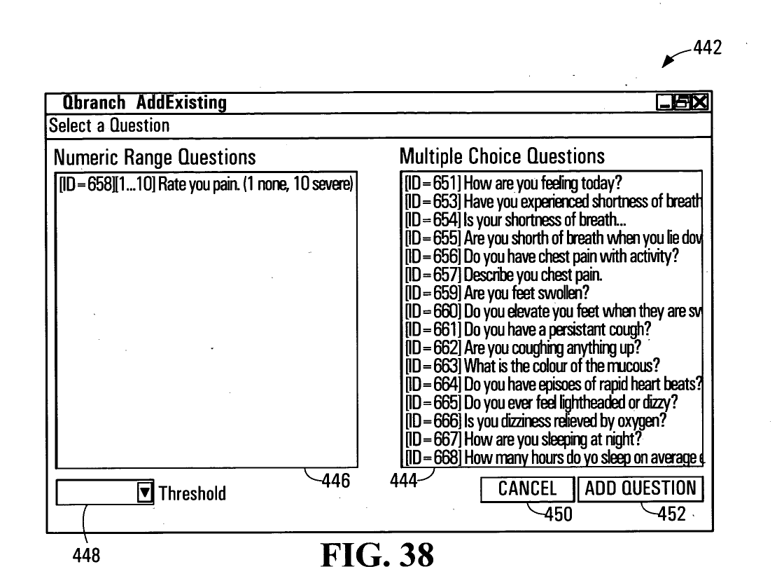

When a user prompt type has been selected, a new user prompt input graphical element is preferably displayed. FIGS. 33 and 34, described above, are illustrative examples of elements which may be displayed in response to selection of new numeric and multichoice questions at 422 and 424, respectively. For an existing stored user prompt, a stored user prompt GUI is preferably displayed. FIG. 38 is an illustrative example of such a GUI.

The stored user prompt GUI 442 of FIG. 38 includes graphical elements 444, 446 which display selectable stored user prompts. The example GUI 442 also includes a threshold setting pulldown menu 448 for stored numeric questions for which the threshold may be changed, and elements 450, 452 for cancelling or confirming stored user prompt selections. Selection of a stored user prompt may be made, for example, by double-clicking on a stored user prompt, highlighting a stored user prompt and selecting an “Add” or similar function at 452, or a drag-and-drop or similar operation to copy or move a stored user prompt from 444 or 446 into another graphical element or window.

Preferably, when a stored user prompt is selected, the selected stored user prompt and responses to the selected stored user prompt are accessed, and the user prompt is added to the patient profile.

It should be appreciated that new user prompt construction need not necessarily involve an intermediate selection screen or GUI. User prompt type selection may, for instance, be provided in a menu or further graphical elements of the GUI 394 (FIG. 36).

A user prompt graphical element and response graphical elements for a new user prompt are preferably displayed at appropriate locations in the GUI 394, depending upon whether the new user prompt is a subordinate user prompt. For example, if an input detected within a response graphical element invoked a new user prompt operation, then the new user prompt is preferably associated with the response graphical element from which the operation was invoked. Referring to FIG. 36, the user prompt graphical element 400 may have resulted from a new user prompt operation invoked by clicking a mouse button while a mouse cursor is positioned on the response graphical element 404.

Although not explicitly shown in FIG. 36, drag-and-drop user prompt configuration to establish branching logic in a user prompt set is also contemplated, such as where a health care provider added a new user prompt without first selecting the appropriate response graphical element with which the new use prompt is intended to be associated.

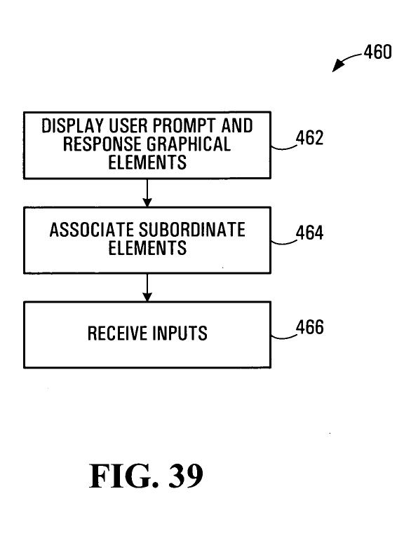

FIG. 39 is a flow diagram of a method of configuring user prompts to be presented to a patient at a remote patient health monitoring system. The method includes displaying at 462 user prompt graphical elements which include user prompts and response graphical elements including permitted responses to the user prompts. Subordinate user prompt graphical elements, including any user prompts to be displayed to the patient upon respective predetermined response to other user prompts, are associated with the response graphical elements of the respective predetermined responses at 464. As described above, this associating may be established using common display attributes, positions, or both. Other techniques for indicating associations between user prompts may also be provided, such as by displaying lines, arrows, or similar explicit indications of a relationship between user prompts and preceding responses.

At 466, inputs are received from a health care provider or server administrator to configure the user prompts.

It should be appreciated that not every user prompt requires a response from a patient. A user response suite may be constructed such that a user prompt instructing the patient to take some other action such as taking a medication may be displayed at a patient system when a predetermined response to a user prompt is entered by a patient.

It should also be noted that although the preceding description refers to configuration of user prompts for a particular patient profile, a health care provider may establish and store a user prompt suite for use in multiple patient profiles or for specific medical conditions, for instance.

Returning now to information management aspects of the present invention, health care providers are the persons designated by the health care organization (Group) to monitor the patients enrolled for monitoring and under the care of the health care group. Primary functions performed by care providers may include monitoring patient vital sign data and responding to any related alert notifications, monitoring health status question responses made by the patients and responding to any related alert notifications, and setting up health status questions, actions, reminders, and monitoring schedules for the individual patients under their care.

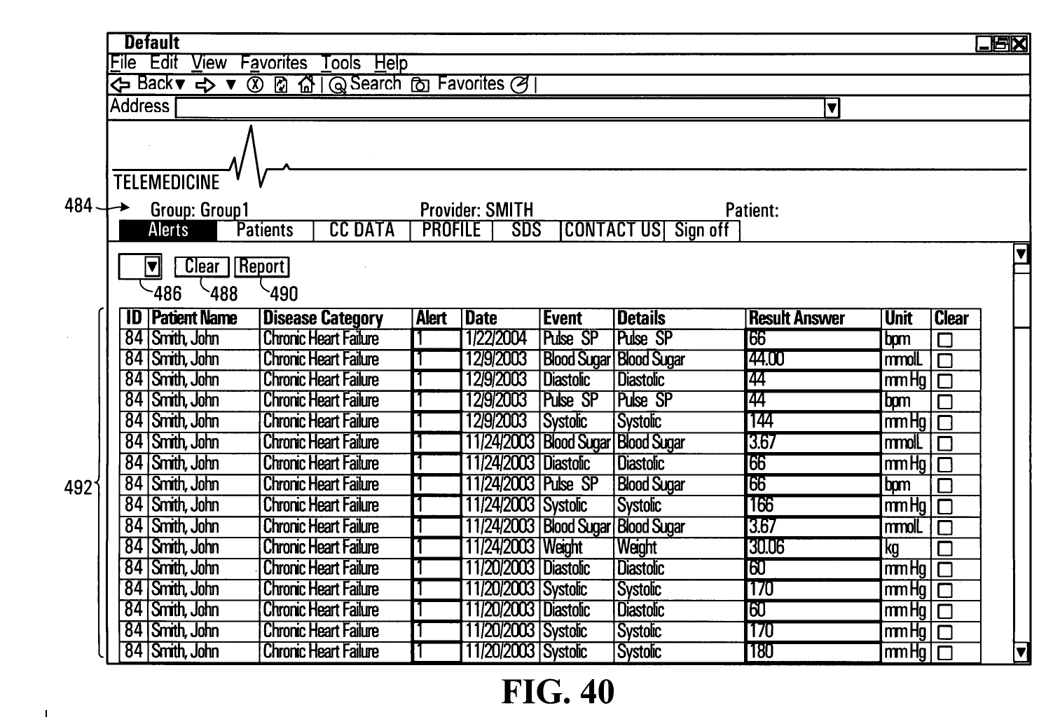

When a care provider logs into the system, they are preferably presented with the alert presentation GUI, an example of which is shown in FIG. 40. Although other initial GUIs may be displayed to a care provider at login, the alerts presentation GUI provides an immediate indication at 492 of all of the patient alert notifications not acknowledged and cleared by the care provider for the patients assigned to that care provider. As alerts may require attention by the care provider on an urgent basis, this GUI may be preferred at login.

As in other GUIs, the alert presentation GUI of FIG. 40 includes an indication at 484 of the group and care provider, to thereby provide an indication of the relationship between currently displayed information and other information stored in the database. The pulldown menu at 486 allows alerts to be filtered by language, the button 488 allows all alerts or selected alerts to be cleared, and the button 490 provides for alert report generation.

The fields on the alert presentation GUI page show the following information for each alert listed at 492:

ID—The ID of the patient with the alert notification;

Patient Name—The name of the patient with the alert notification;

Disease Category—Identifies the primary disease category associated with the patient;

Alert—Signifies an alert condition;

Date—Date when the measurement or response which caused the alert was made by the patient;

Event—Identifies the parameter that generated the alert;

Details—This field contains more detailed information about the event being alerted, for example the vital sign parameter or the question whose response generated the alert;

Result/Answer—The value of the parameter in the Event or Details field, which was found to be outside a set threshold or to meet an alert condition. For health status question responses, this may be the response that caused the alert to be raised;

Unit—For vital sign parameters, this field displays the units of measure for the parameter;

Clear—Provides check boxes for selection of alerts to be cleared using the Clear button 488.

The alerts in the list may be sorted, for example, by clicking on a heading. Sorting by only some or all of the headings may be supported.

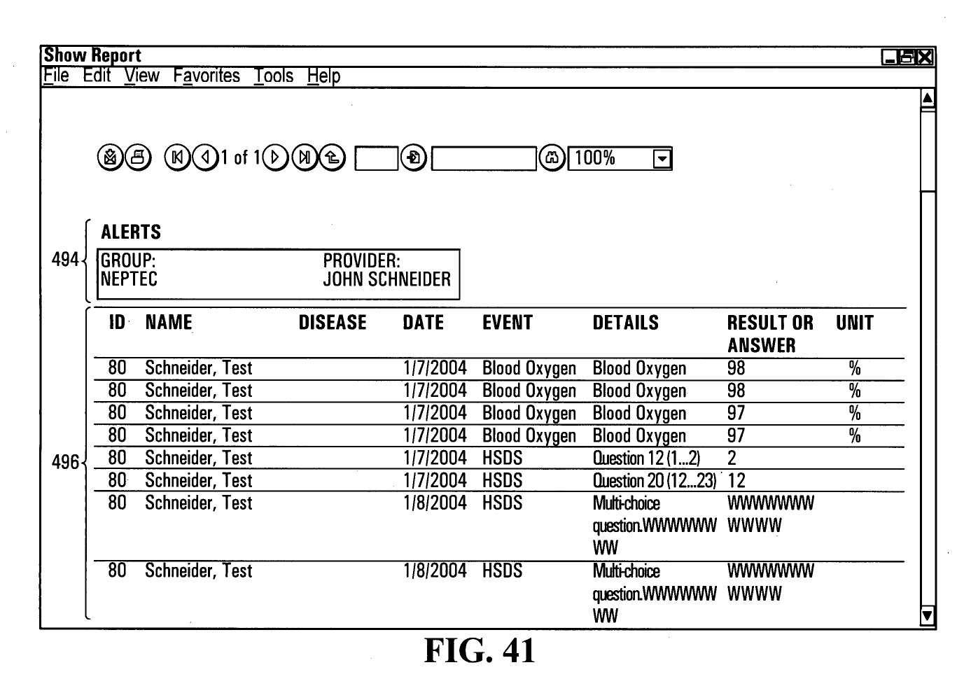

Pressing the Report button 490 causes another GUI, illustratively a popup window, to be displayed, an example of which is shown in FIG. 41. From this view, the user may output the report to a file or to a printer, for example. The example report indicates the group and care provider at 484 and lists alerts at 496.

A list of all patients assigned to the care provider is displayed when the patients tab is selected. A patient information management GUI such as shown in FIG. 19 may be displayed. From this GUI, the care provider can edit the patient information fields as described above. Although adding new patients may be a group administrator function, it should be appreciated that care providers may add new patients in some embodiments of the invention.

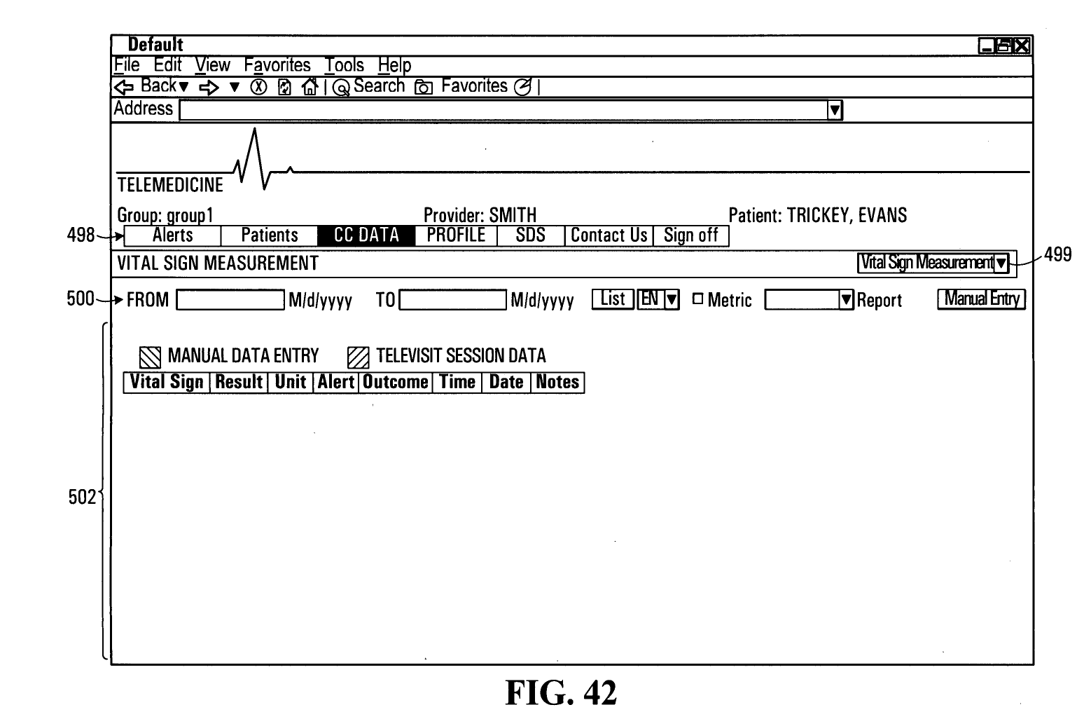

To view a patient's vital sign information as received from a patient system, for example, the patient is first selected from the patient information management GUI and a patient system tab, illustratively the CC Data tab in FIG. 19, is then selected. This causes a patient health information management GUI, such as shown in FIG. 42, to be displayed.

In the example GUI of FIG. 42, group, care provider, and patient are indicated at 498, data entry fields are provided at 500, a pulldown menu for selecting the type of health information to be displayed for the patient is provided at 499, and a list of stored health information of the selected type is displayed at 502. As shown, the example GUI of FIG. 42 relates to vital sign measurements, which may be a default selection for this GUI.

The fields on the GUI of FIG. 42 show the following information:

Vital Sign—Displays the vital sign parameter name (e.g., blood oxygen, blood sugar, weight, etc.);

Result—Displays the resulting measured value;

Unit—Displays the units of measure for the parameter;

Alert—Indicates whether or not the reading triggered an alert notification. Any list entry containing an alert may also be highlighted or otherwise distinguished from other entries for easy identification;

Outcome—Indicates whether the measurement was successfully taken (Success), an error was detected while the measurement was being taken (Failed), or the measurement was skipped by the patient (Skipped);

Time/Date—Displays the date and time the measurement was taken; and

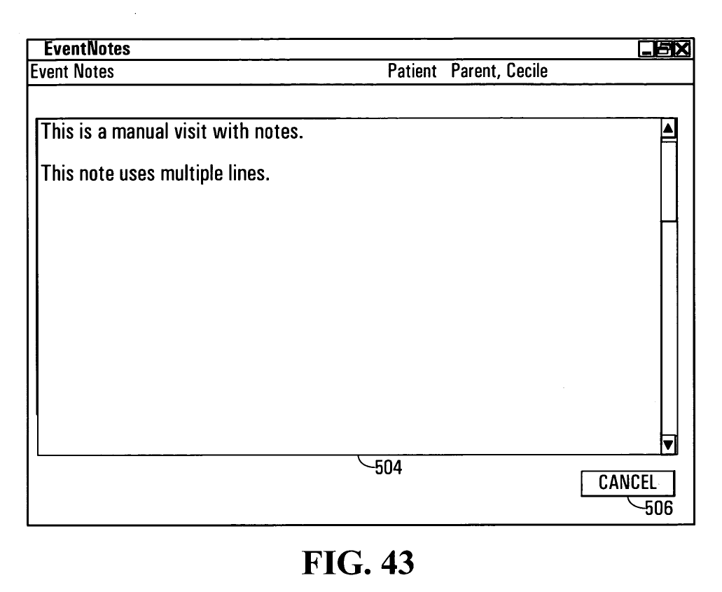

Notes—Clinical notes entered using the manual data entry screen described below. Clicking on a note causes a patient health information notes presentation GUI such as shown in FIG. 43 to be displayed. The GUI of FIG. 43 includes a display graphical element 504 displaying the full note for review and a control graphical element 506 for returning to the patient health information management GUI of FIG. 42.

To list the health information, measurements in the example GUI of FIG. 42, for any given day or range of days, the corresponding dates may be entered in the From and To fields at 500. Clicking the List button then displays health information for the entered date or date range. To display all health information again, the List button may be selected with the date fields cleared. Health information may also be sorted by language using the pulldown menu at 500. Measurement units may also be selectable using the check box at 500.

As in other GUIS, the list in a health information management GUI may be sorted, such as by clicking a list heading.

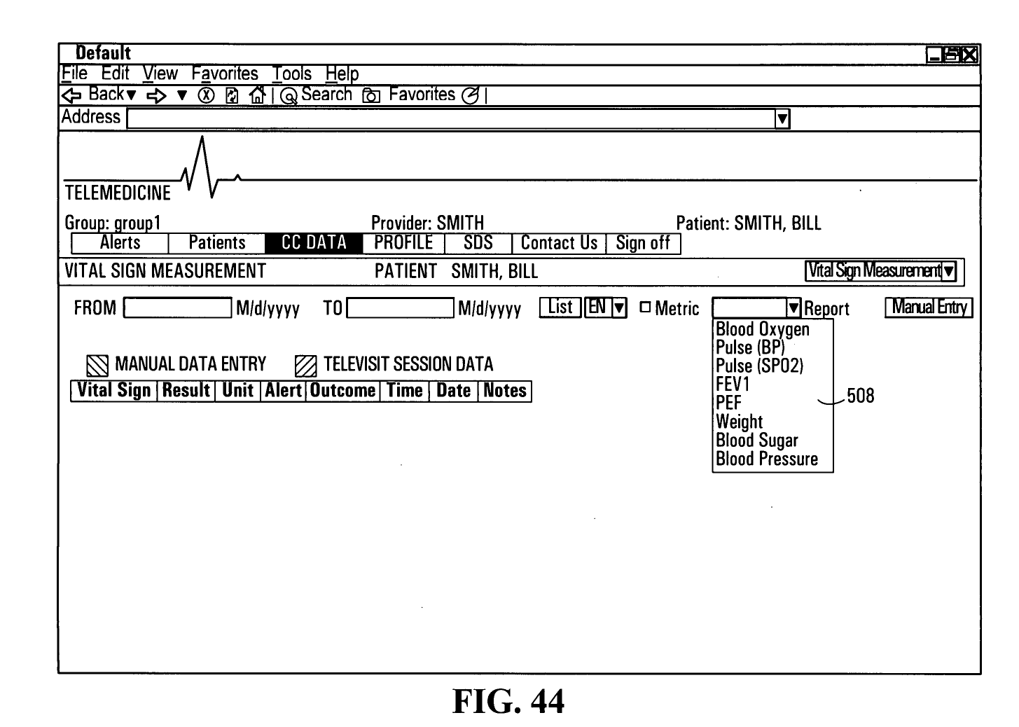

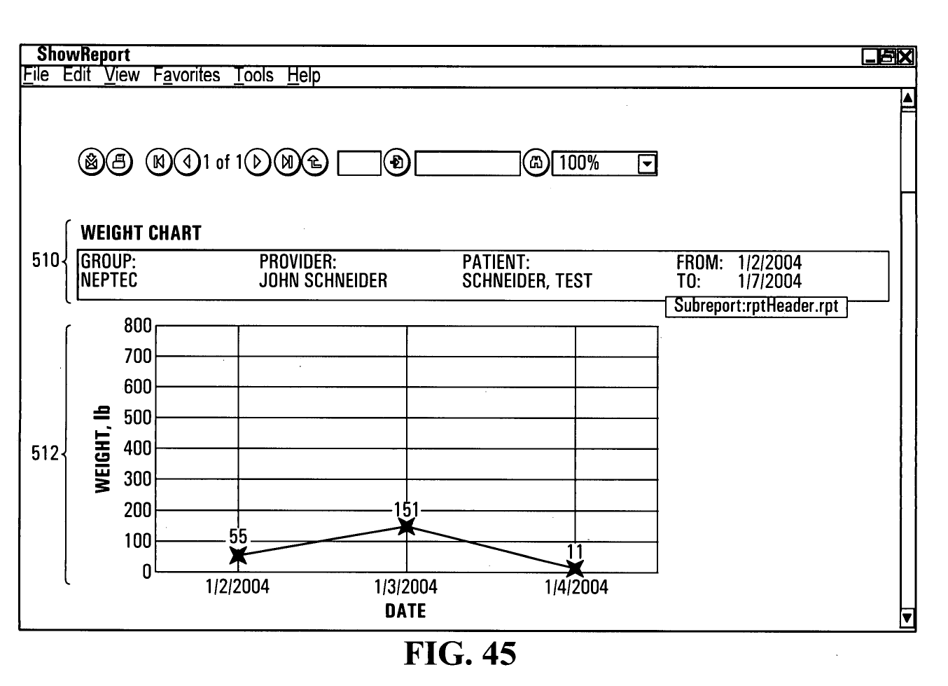

Using the selections available in the Report pulldown menu, as shown at 508 in FIG. 44, for example, graphical reports for individual vital sign types can be created. FIG. 45 shows an example graphical report. From the graphical report display, which includes group, care provider, patient, and possibly further information associated with the health information in the graphical report at 510 and a graphical representation of the selected health information at 512, a care provider user may output the report to a file or to a printer.

In situations where a care provider may be speaking to a patient directly over the telephone or a videophone, it may be necessary to record some data manually.

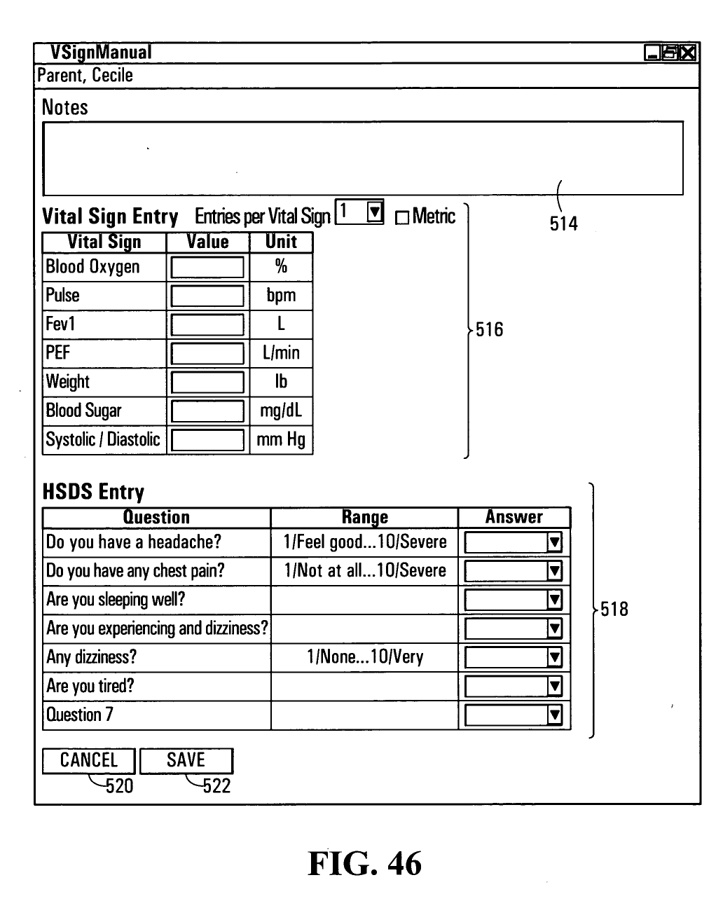

Clinical notes, vital sign data and HSDS responses can be entered manually using a manual entry screen accessed by clicking on the manual entry button on the patient health information management GUI, for example. FIG. 46 shows an example manual patient health information entry GUI.

Using this GUI, notes, vital sign data, and/or Health Status Data Set responses may be entered at 514, 516, 518, respectively. Multiple sets of vital sign measurements can be entered at once by selecting the number from the Entries per Vital Sign pulldown menu. It should be appreciated that it may not be necessary to enter data in all of the fields provided. In one embodiment, however, it is mandatory to also enter a vital sign value or an HSDS entry answer when entering notes, as the notes entry is displayed only in a Vital Sign Measurement screen or HSDS Response screen (below).

Manually entered data may be cancelled and discarded or saved using the control graphical elements 520, 522. An entry for any saved manually entered data is added to a health information list, such as the vital sign measurement list in FIG. 42.

In order to distinguish manually entered data from data automatically collected at a patient system, data entered manually may be highlighted, for example, when displayed on the Vital Sign Measurement and the HSDS Response pages. Entries in a vital sign measurement or other health information list may be further distinguished from entries corresponding to generated alerts such as by using different respective colors or display styles for entries corresponding to manually entered data and alerts. The date and time displayed for manually entered data corresponds to the date and time that the manual entry data was saved.

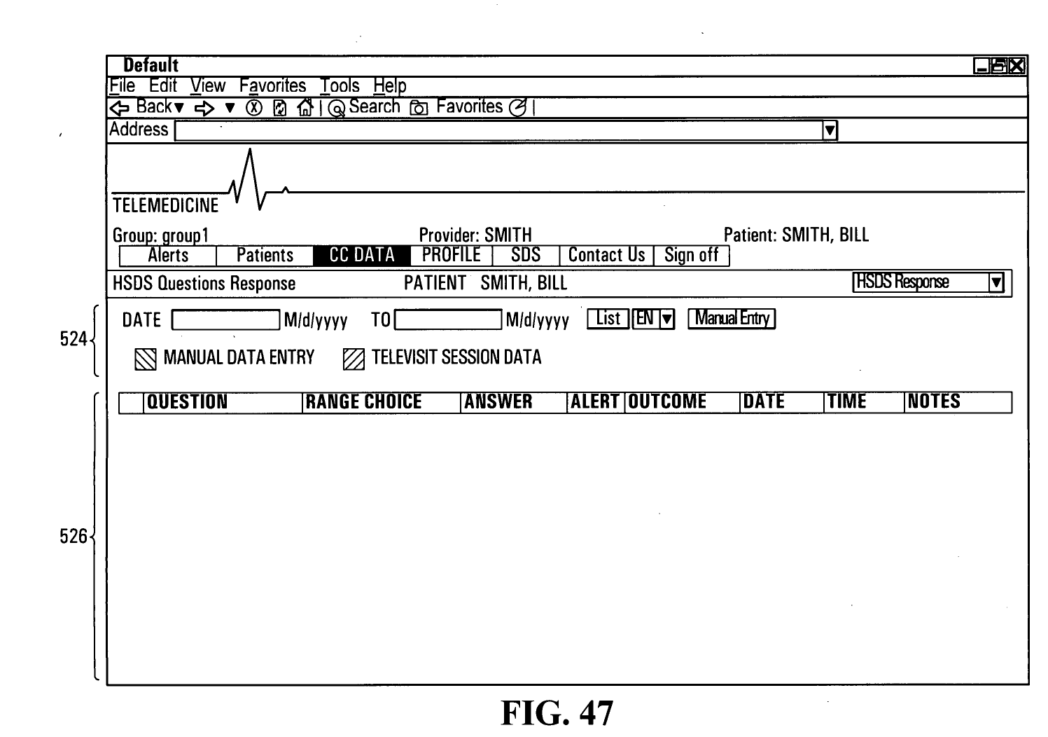

To view a patient's responses to health status questions, an HSDS Responses or similar option is selected from the pulldown menu 499 in FIG. 42. This causes the display of a question or user prompt response presentation GUI, an example of which is shown in FIG. 47.

Data entry fields are provided in the GUI of FIG. 47 are provided at 524, and patient responses are listed at 526. The response list fields on this GUI show the following information:

#—The sequence number or other identifier of the question in the patient's HSDS;

Question—Displays the health status question to which the patient responded;

Range/Choice—Displays the possible responses to the question;

Answer—Displays the actual response selected by the patient;

Alert—Indicates whether or not reading triggered an alert notification. As described above for vital sign measurements, any entry containing an alert may also be highlighted or otherwise distinguished from other entries;

Outcome—Indicates whether the response was successfully recorded or the question was skipped by the patient (Skipped);

Date/Time—Displays the date and time the response was made;

Notes—Clinical notes entered using the manual data entry screen. Clicking on a note causes a GUI such as shown in FIG. 43 to be displayed.

The date, list, language pulldown menu, and manual entry key are used substantially as described above with reference to vital sign measurements.

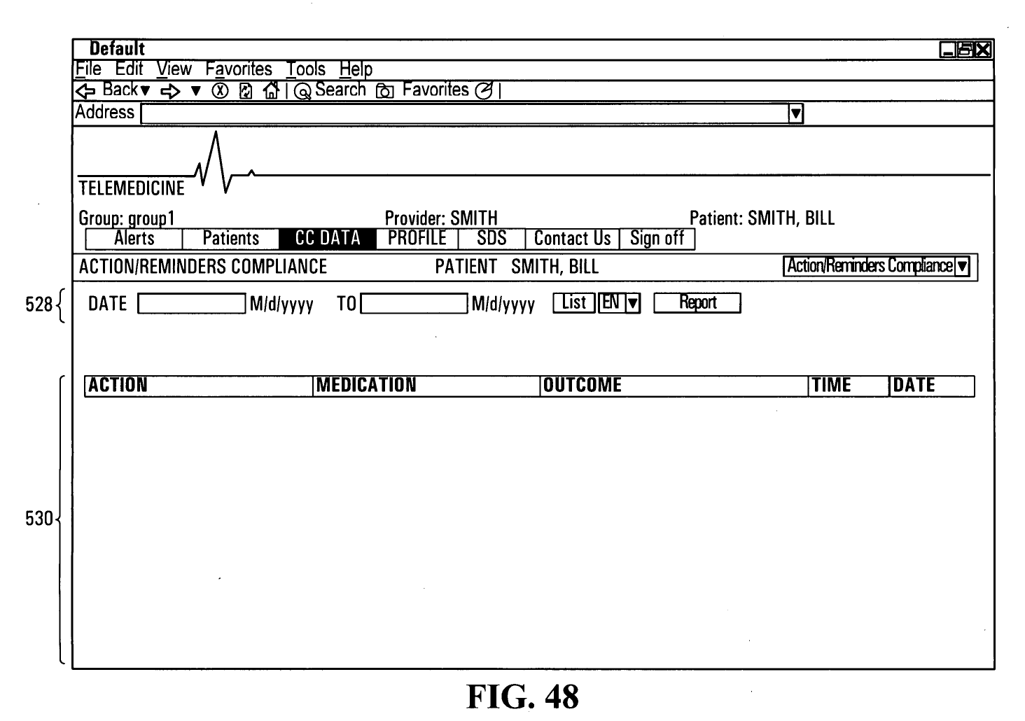

To review the patient's compliance with the action/reminders, an action/Reminder Compliance option may be selected from the pulldown menu 499 (FIG. 42), which causes the display of an action/Reminders Compliance information presentation GUI such as shown in FIG. 48.

The GUI in FIG. 48 includes data entry fields at 528, and action/reminder compliance information at 530. The list fields show the following information:

Action—Displays the action or reminder notice;

Medication—If the action involved taking a medication, this field displays the medication name;

Outcome—Indicates whether the response was successfully acknowledged or the action was skipped by the patient (Skipped); and

Time/Date—Displays the time and date the acknowledgement was made.

As above, functions of date and language limiting, as well as reporting, are provided at 528.

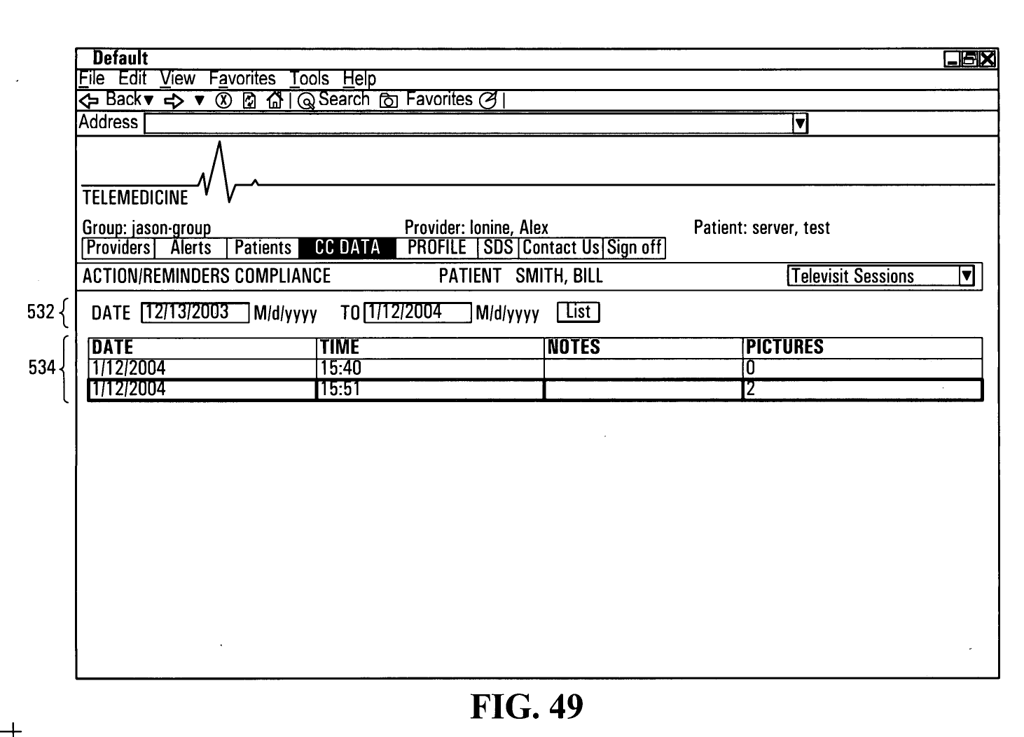

A further function that may be supported from the patient health information management GUI of FIG. 42, such as by selection of an option in the pulldown menu 499, is viewing a summary of the televisit sessions conducted with the patient. Televisit sessions refer to remote monitoring sessions conducted between a health care provider and a patient, such as through a health care provider system 18 and a patient system 10 as shown in FIG. 1, and have been described in detail in the above-incorporated provisional application 60/557,714, and International application <Attorney Docket No. 51188-3>. An example of a televisit session management GUI is shown in FIG. 49.

The list at 534 in FIG. 49 may be filtered using the entry fields and List button at 532, as described above. The fields in the televisit list at 534 show the following information:

Date/Time—The date and time when the televisit session took place;

Notes—Clinical notes entered during the televisit session; and

Pictures—Displays the number of pictures taken during the televisit session.

The results of the vital sign measurements and health status data responses collected during a televisit session may be reviewed through the GUIs of FIGS. 42 and 47 as described above. Health information entries in these GUIs corresponding to televisit data may be distinguished from other entries, using different attributes such as font, underlining, bolding, and/or highlighting, for example. Different highlighting colors may be used, for example, for entries with alerts, manually entered data, and televisit data, to provide a clear indication of different types or sources of patient health information.

Televisit clinical notes and still pictures are accessible by clicking on the date field corresponding to the televisit session in the example GUI of FIG. 49, although separate access by selecting the fields may also or instead provided.

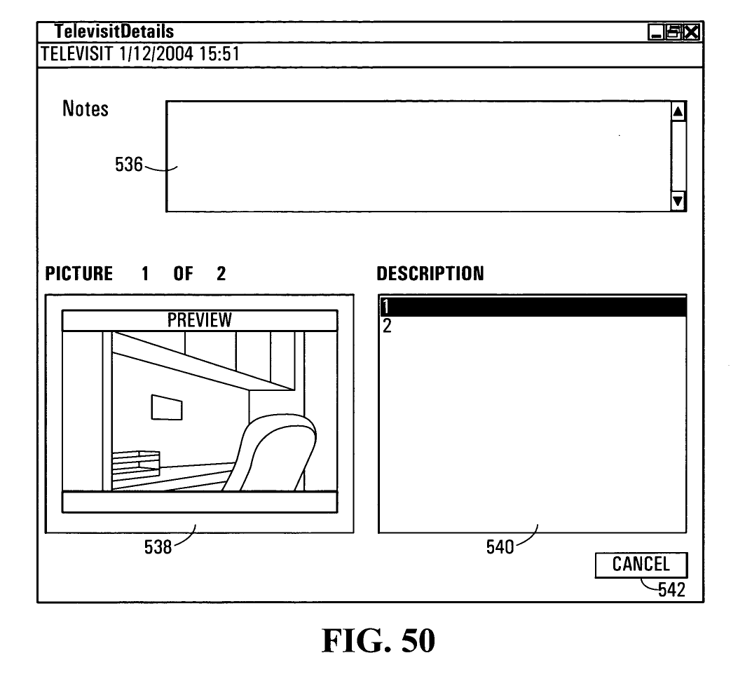

FIG. 50 shows an example televisit session information presentation GUI. In this example, GUI, notes, pictures, and any descriptions relating the pictures are presented at 536, 538, 540, respectively. The control graphical element 542 allows a user to return to the televisit session management GUI of FIG. 49.

As described briefly above, a patient Health Status Data Set is a protocol of questions designed for a patient. This is the list of questions downloaded to a patient system. The patient is subsequently prompted to respond to the HSDS at scheduled times.

The HSDS questions may be selected from the Standardized Data Set questions as described above, but may also include customized questions, designed specifically for a patient, and not included in any Standardized Data Set. This level of customization of both an SDS and per-patient HSDSs is not provided by currently known patient health monitoring systems.

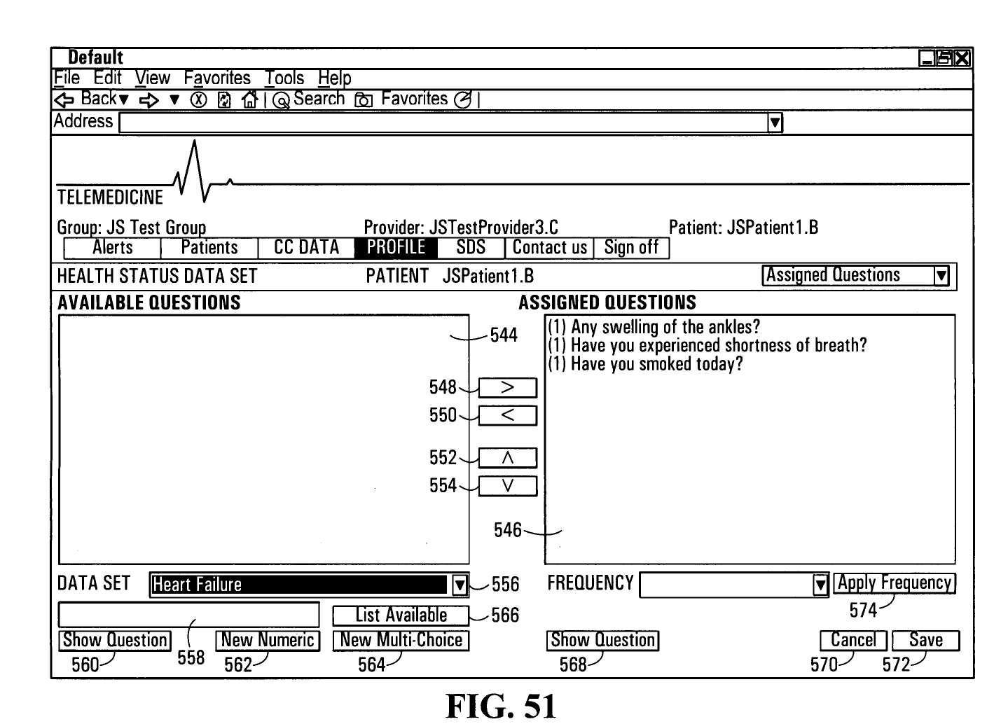

To edit a patient's Health Status Data Set, a patient is selected from the patient list in the GUI of FIG. 19, for example, and the Profile tab is then selected to display a patient profile management GUI such as shown in FIG. 24. An “assigned questions” or analogous option is then selected from the pulldown menu at 229 (FIG. 24), which causes display of an HSDS configuration GUI. An example configuration GUI for an HSDS is shown in FIG. 51.

The GUI of FIG. 51 includes display and control graphical elements 544-572. The column 544 is used to display the questions from the Standardized Data Sets. The column 546 displays the questions in the patient specific Health Status Data Set.

The SDS pulldown menu at 556 contains the names of all Standardized Data Sets, and may also include the HSDS for the patient, identified in the list by the patient's name for instance. To add questions from a data set, the data set name is selected at 556, and all of the questions from the selected data set are displayed in the column 544.

List filtering, question editing, adding of new questions, and cancelling or saving changes to an HSDS using the GUI of FIG. 51 will be apparent from the foregoing description of allergies configuration, for example.

To set the frequency defining how often a question is to be asked, a question may be selected in the column 546. A subsequently selected, or alternatively entered, frequency is applied to the question using the control graphical element 574. A default frequency, illustratively once per day, may be set if no frequency is specifically set. The frequency may be shown in parentheses in front of each question in the assigned list at 546.

The GUI of FIG. 51 thereby provides for customizable, per-patient user prompts. User prompts, questions in the example of FIG. 51, may be selected from predetermined SDSs or manually entered. In accordance with an embodiment of the invention, both SDSs and HSDSs are customizable. No currently known health monitoring schemes provide for this level of customization.

Action/reminders are prompts to the patient to perform some action or to acknowledge that an action has been performed. For example, a patient may be reminded daily to take a specific medication at a specific time.

A health care provider may define a list and schedule of action/Reminders for each patient. The action/Reminder list is downloaded to the patient system, where the patient is prompted to acknowledge each action/reminder at the scheduled times.

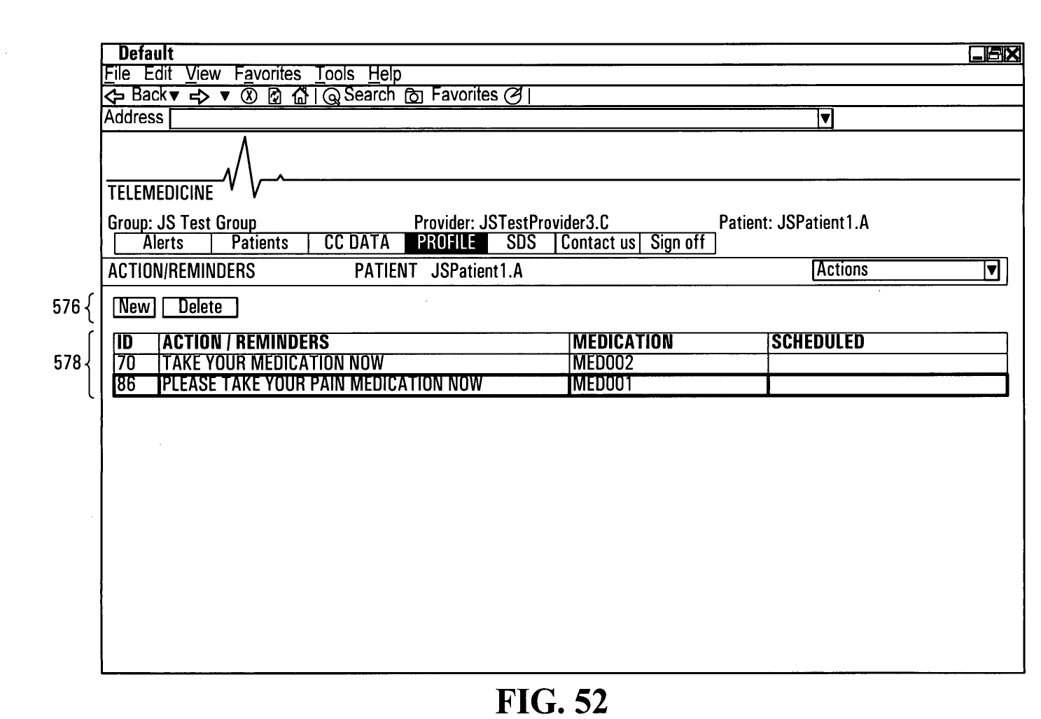

An action/Reminder management GUI, such as shown in FIG. 52, is accessible through the patient profile management GUI of FIG. 24, for example, by selecting an actions or similar option from the pulldown menu 229.

The example action/reminders management GUI of FIG. 52 includes control graphical elements at 576, and a list of actions and reminders 578 for a selected patient which contains the following information for each action/reminder:

ID—A unique ID identifying the action/reminder;

Action/Reminder—Displays the action/reminder message;

Medication—If the action involves taking a medication, this field displays the name of the medication; and

Scheduled—This field indicates, with an ‘x’, if the action/reminder has been put into the patient's event schedule as described below.

Action/reminders may be created and added to the list or deleted and removed from the list using the control graphical elements at 576.

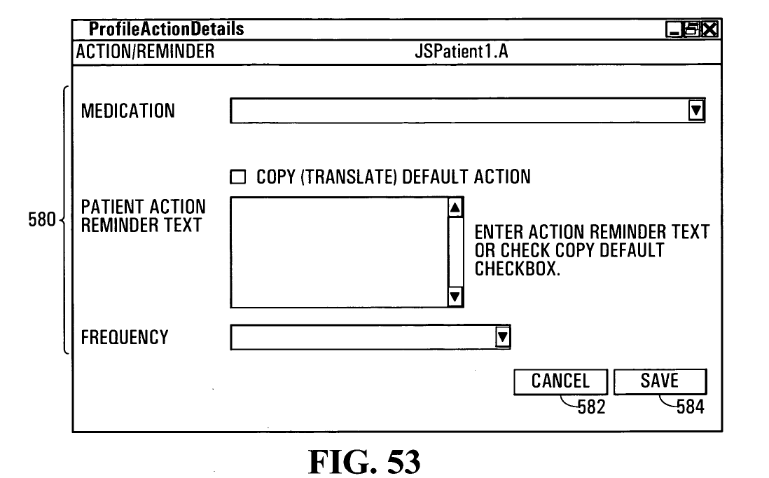

An edit function for action/Reminders is accessible in the GUI of FIG. 52 by selecting a field in an action/Reminder list entry. An action/reminder entry GUI such as shown in FIG. 53 may then be displayed.

If an action/reminder relates to a medication, then the medication may be selected from the Medication pulldown menu shown at 580. The medication pulldown menu may include medications which have been assigned to the patient as described above, or possibly all available medications.

The text of the action/reminder message is entered in the patient action reminder text field. If there is a default action text message associated with the selected medication, then clicking the copy default action checkbox selects the default message and no text need be entered in the patient action reminder text field.

To set the frequency defining how often an action/reminder message is displayed to the patient, a frequency is selected from the frequency pulldown menu. A frequency of once per day, for example, may be set as the default if no frequency is specifically set.

Action/reminder information entered at 580 may be cancelled or saved using the control graphical elements 582, 584.

A patient system performs its functions when installed at a patient site based on a schedule of events designed for the particular patient. Events may include the following, for example, and possibly other types of event:

Vital sign measurement (e.g., take blood pressure measurement);

Health Status monitoring (e.g., respond to a set of questions);

Action/reminder (e.g., prompt to take medication);

Data communication (e.g., transmit data to the server).

The first three of the above example events involve patient interaction with the patient system, whereas the last event is transparent to the patient and involves the patient system and the server.

Health care providers schedule the events for each patient, and the schedules are then downloaded to the individual patient systems, where they are processed.

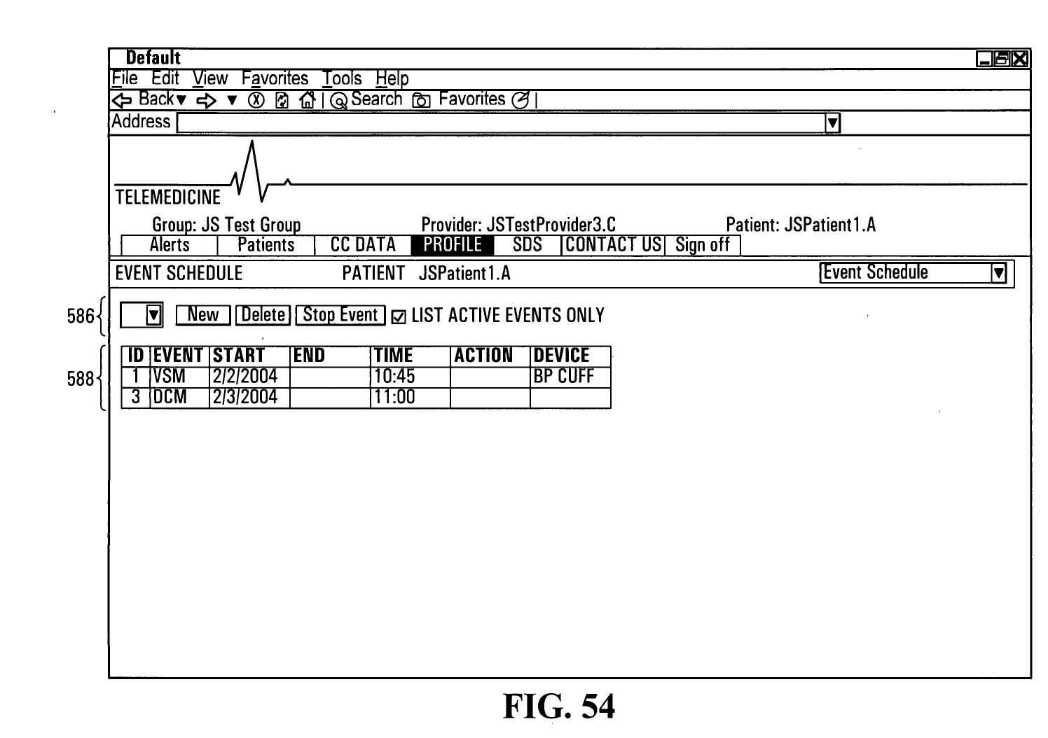

Event schedule management functions for a particular patient may also be accessible through the pulldown menu 229 of the patient profile management GUI of FIG. 24. FIG. 54 shows an example of a patient event schedule management GUI.

Data entry and control graphical elements are provided at 586, and scheduled events are listed at 588. The events list contains the following information for each event:

ID—A unique ID identifying the scheduled event;

Event—This field displays the type of event scheduled, including DCM (Data Communication Event), HSM (Health Status Monitoring Event), VSM (Vital Sign Monitoring Event), and ARM (Action/Reminder Event) in one embodiment;

Start/End—Displays the effective dates of the scheduled event. The Start date is the date that the event was entered into the schedule. The End date is the date that the event was “Stopped”. An event is “Stopped” by selecting it and clicking the Stop Event button at 586, for example, which effectively removes the event from the schedule. An event with an end date may continue to be displayed in the event listing for reference purposes;

Time—The time of day that the event is scheduled for the patient;

Action—If the event is an action/Reminder event type, this field displays the action reminder message; and

Device—If the event is a Vital Sign Monitoring Event, this field displays the type of device used to take the vital sign measurement.

The List Active Events Only check box at 586 allows a care provider to display only active events (i.e., events with no past end date).

A new schedule entry may be created by selecting an event type from the pulldown menu at 586 and clicking on the New button. The new scheduled event appears as a new entry in the list. The delete button at 586 allows an event to be deleted and removed from the list. In one embodiment, events that have been downloaded to a patient system are stopped instead of being deleted.

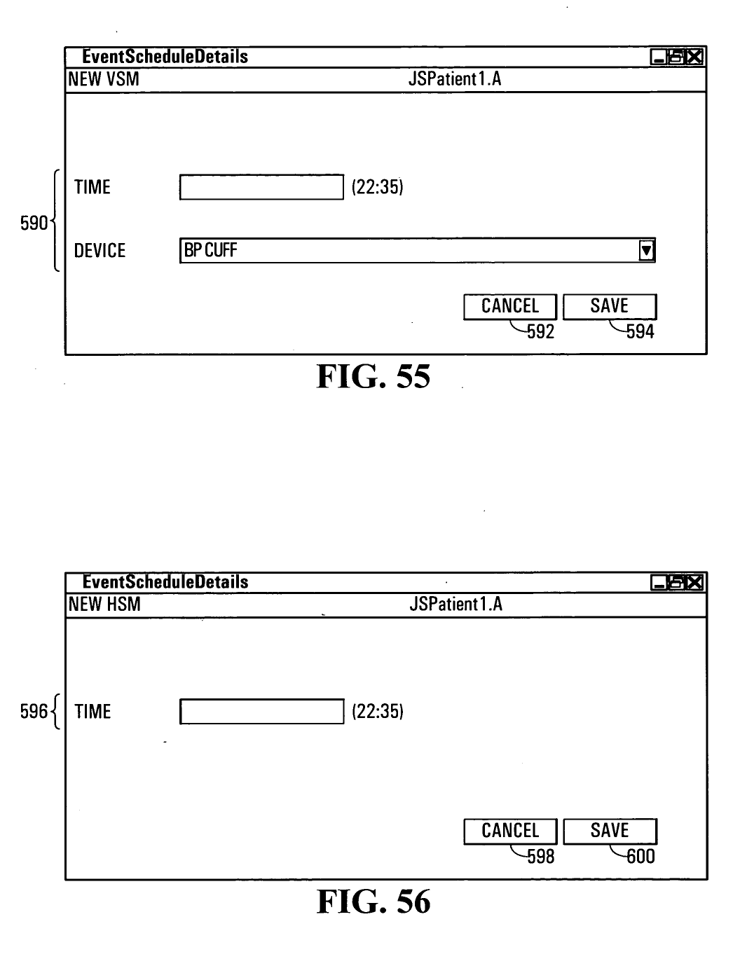

FIG. 55 shows an example Vital Sign Monitoring type (VSM) event schedule entry GUI, displayed by clicking on a VSM field in an event list, for example. In the GUI of FIG. 55, the time of day when the event is to be performed by the patient is entered in the Time field provided at 590. For patient convenience, it may be preferable, if possible, to schedule events or sets of events to occur at the same time of day to minimize the number of interruptions to the patient's daily activities. A suggested time may thus be provided as shown adjacent to the Time field.

For a VSM event, a type of device to be used to take the vital sign measurement is selected from the Device pulldown menu.

Data entry for a VSM event may be cancelled or saved using the control graphical elements 592, 594.

Editing of HSM, ARM, and DCM events may be accomplished in a substantially similar manner. FIGS. 56-58 respectively show example event entry GUIs for these types of events. These GUIs, like the VSM event entry GUIs, may be displayed by clicking on a corresponding event field in the GUI of FIG. 54, for example.

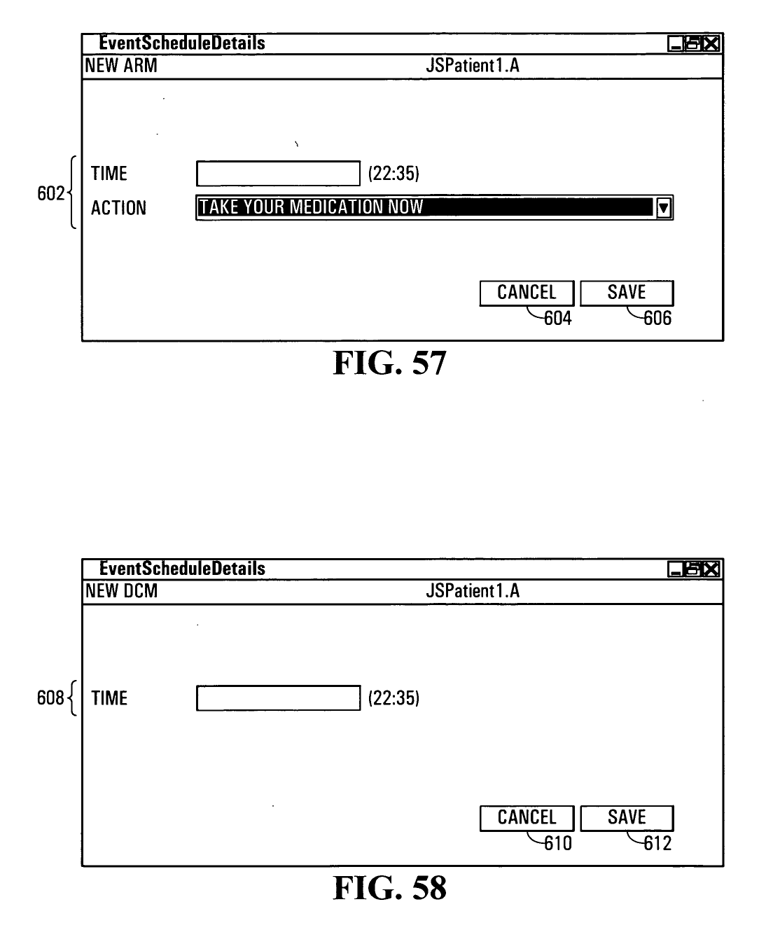

For an HSM event (FIG. 56), the time of day when the event is to be performed by the patient is entered in the Time field at 596, and cancelled or saved using the control graphical elements 598, 600. In the ARM event entry GUI of FIG. 57, event information is entered at 602. The time of day when the event is to be performed by the patient is entered in the Time field, an action/reminder message to be displayed to the patient at that time is selected from the action pulldown menu, or may alternatively be manually entered, and event information is cancelled or saved using the control graphical elements 604, 606. DCM events are configured in the GUI of FIG. 58 by entering at 608 the time of day when the upload of data to the server is to occur. As above, entered DCM event information is cancelled or saved using the control graphical elements 610, 612. It may be generally preferred to schedule a DCM event as a last daily event, such that all data collected during any day is transferred to the server on the same day. In another embodiment, a patient system transmits data to the server as it is collected, in which case DCM events need not be separately configured.

An alert is a notification of measurement values, health status responses or action/reminder responses (absolute values or trends in values or responses) outside of defined limits.

Care providers may create alert criteria for any patient defining data limits or trend thresholds. When the limits or thresholds are exceeded, an alert notification is triggered. The criteria may be applied to substantially any event. Alerts may also be triggered if the patient skips or fails to acknowledge any scheduled events, or if the patient system fails to contact the server for more than a predetermined period of time, for example, illustratively 24 hours.

When data is received from the patient system for a given patient, alert criteria are applied to the data, and if necessary, an alert notification is made automatically, such as via e-mail, to one or more designated care providers.

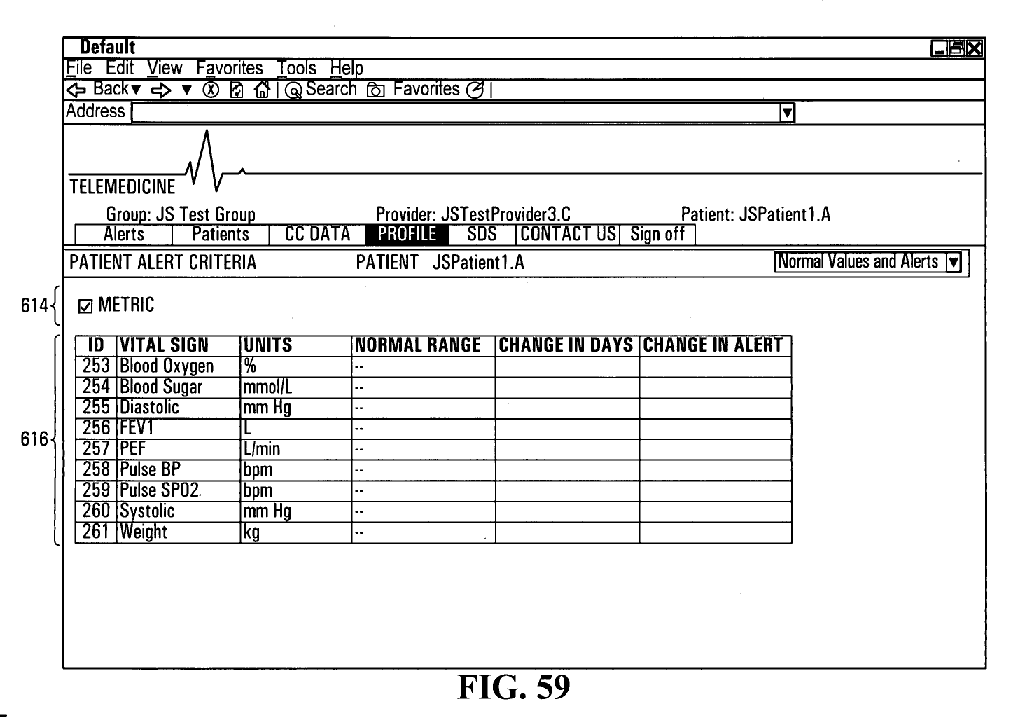

Alert criteria functions are accessible as another menu option in the pulldown menu 229 of the patient profile management GUI of FIG. 24 in one embodiment. An example alert criteria management GUI is shown in FIG. 59.

The GUI of FIG. 59 provides a unit selection check box at 614 and a list of alert criteria for each possible vital sign measurement parameter at 616. The list at 616 contains the following information for each list entry:

ID—A unique ID identifying the entry;

Vital Sign—Displays the vital sign name;

Units—Displays the units of measure for the vital sign;

Normal Range—Displays the range of values over which an alert is not triggered. These are considered the normal and acceptable range for the selected patient, and may be established by the health care provider based on past vital sign measurements, for example; and

Change in Days/Change to alert—These fields are used for trending measured vital sign parameters. They indicate that an alert will be triggered if the measured parameters change by more than the Change to alert units over a Change in Days period of time.

The alert criteria shown in FIG. 59 relate to vital sign measurement alerts. As described above, alert criteria for health status questions may be defined with each question as part of the data sets.

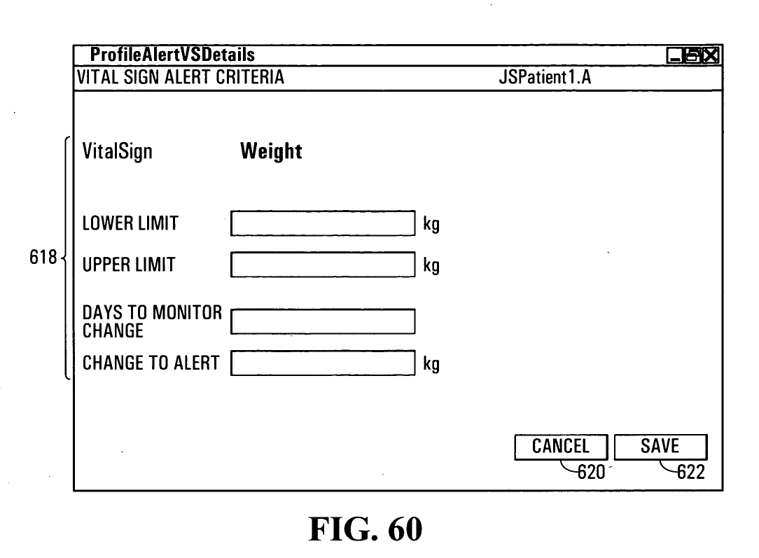

Alert criteria parameters are accessible from the GUI of FIG. 59 for editing by clicking on the parameter name in the Vital Sign field or the ID, for example. This causes display of an alert criteria definition GUI such as shown in FIG. 60, in which an identification of the vital sign and data entry fields are provided at 618 and control graphical elements are provided at 620, 622.

If a threshold criterion is to be set, then the lower and/or upper limits of an acceptable or normal range are entered in the Lower Limit and the Upper Limit fields in the indicated units. This means that any measured value that is outside these limits triggers an alert.

If a trended criterion is to be set, then the period, in days, over which the data is to be trended is entered into the Days to Monitor Change field. The number of units of acceptable change over that period of time is entered into the Change to alert field. This means that any change in measured units greater than that specified over the number of days triggers an alert. In one embodiment, both threshold and trended criteria may be specified for any parameter.

According to an embodiment of the invention, the server can be configured to notify one or more care providers automatically when an alert is triggered. This is intended to prompt the care provider to log into the server, review the status of their patients, and address any issues.

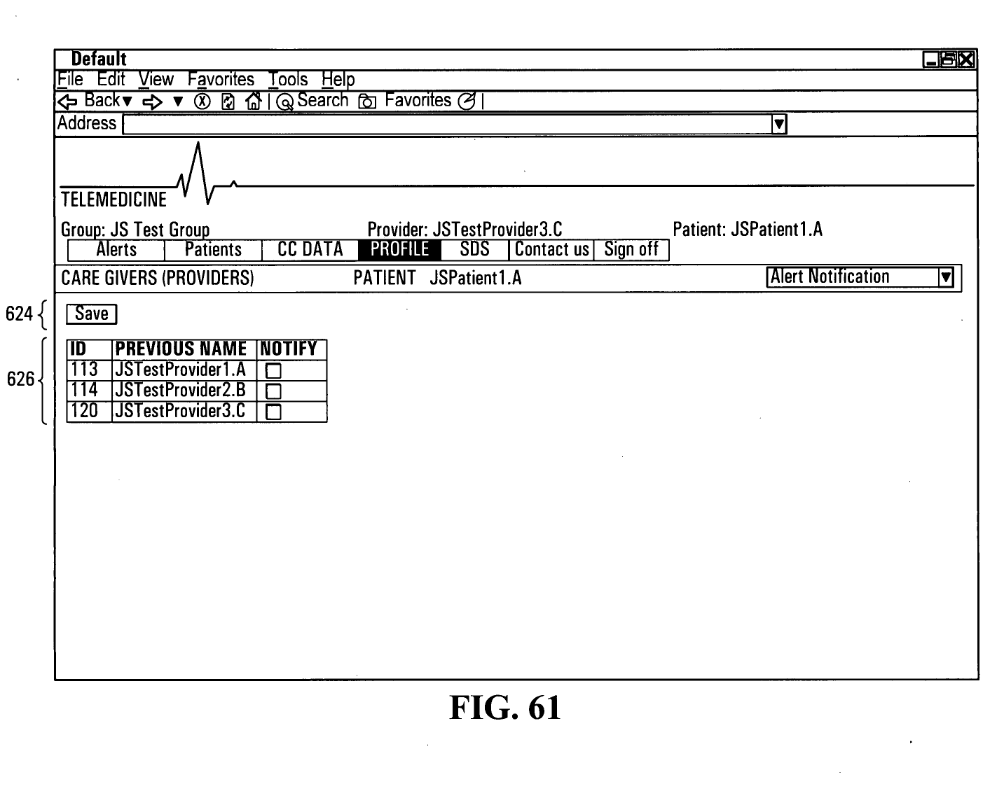

To identify those care providers that should be notified when an alert is triggered for a given patient, an alert notification setup GUI may be displayed by selecting an alert Notification option from the pulldown menu 229 in the patient profile management GUI in FIG. 24, for example. An example alert notification setup GUI is shown in FIG. 61.

The GUI of FIG. 61 provides a control graphical element at 624 and a list of care providers assigned to the care of a selected patient, identified below a banner in the GUI, at 626. Any of the care providers may be designated to receive notifications when an alert is triggered for the patient by checking the check boxes beside the care provider name(s) at 626 and clicking the Save button at 624. The checked care providers receive alert notifications for the patient.

In an alternative embodiment, alert notification is configured during alert criteria entry or editing, such as by providing a pulldown menu in the GUI of FIG. 60, for example. Notifications may also be configured on a per-criteria basis by providing multiple check boxes in the GUI of FIG. 61.

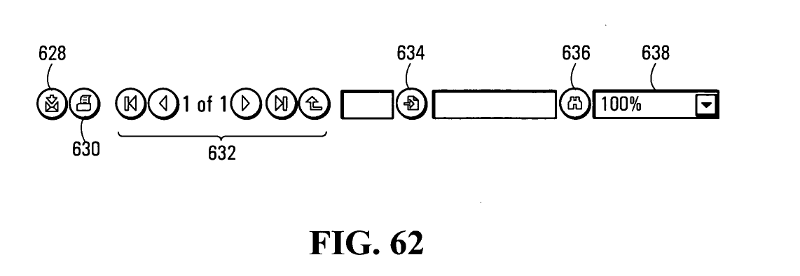

The example reports described briefly above may be displayed with a toolbar such as shown in FIG. 62. The function of each of the controls 628, 630, 632, 634, 636, 638 is described below.

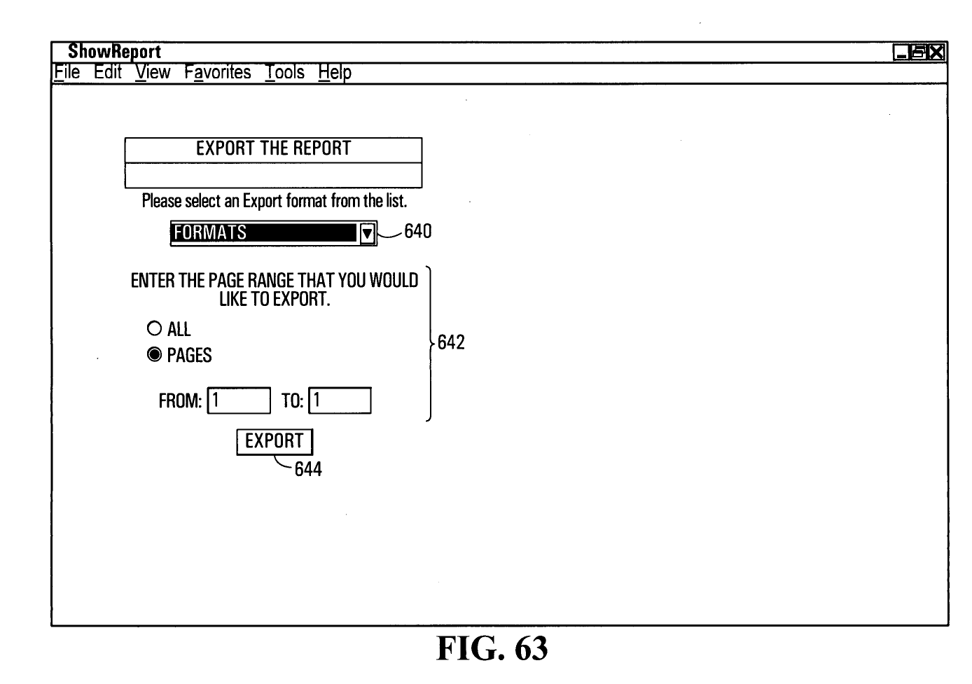

Using the control 628, it is possible to export a displayed report to a number of file formats that can be saved on a hard drive or other storage device at an access system, for example. Clicking on this icon causes an export report GUI such as shown in FIG. 63 to be displayed. As shown in FIG. 63, an export file format may be selected at 640, a range of pages is selectable at 642, and file export is started using the Export button 644. Any export file format may be supported, provided corresponding file translation utilities are available at either a server or an access system.

An export operation may be cancelled or aborted, for example, by pressing a backspace key on a keyboard or providing a Cancel or similar control graphical element in the GUI of FIG. 63.

Upon initiation of an export operation, a dialog may be displayed to allow a destination file name and location to be specified.

A hard copy of a report may be printed on a printer by clicking on the Print control 630. As will be apparent, a print GUI or screen may then be displayed to allow selection of pages to be printed and possibly other print options.

The navigation controls 632 are provided to facilitate page navigation on multi-page reports. The Goto control 634 represents a further navigation control, and provides for display of a particular page of the report corresponding to a page number entered in an adjacent user input field.

A report may be searched by clicking on the Search control 636. The report is searched for a search string entered in the text entry field adjacent the search control 636.

The zoom control 638 changes the size of the text of a displayed report.

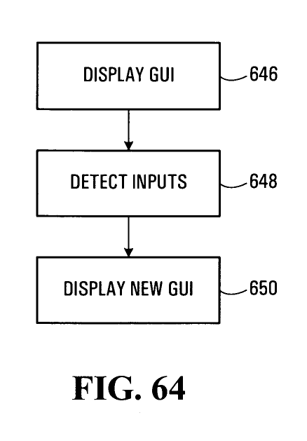

FIG. 64 is a flow diagram of a method of health care information management according to an embodiment of the invention, and represents a general view of the operations described above. At 646, a GUI is displayed. Inputs are detected within input areas defined by graphical elements within the GUI at 648, and a new GUI is then displayed at 650. A new GUI displayed at 650 may be a data entry GUI, an information management GUI, or a report GUI, for example. Subsequent user inputs in the new GUI may then be detected, input information may be stored in a server database, and another GUI showing the input information may be displayed. As will be apparent from the foregoing, embodiments of the invention may involve many different GUIs and related functions.

Various embodiments of the invention relating to management of information at a server database have thus been described. Information may be presented to a user at any of the server 14, the health care provider system 18, or the access system 19 (FIG. 1). Although only the server 14 has been described in detail above, it will be apparent to those skilled in the art that a health care provider system and an access system may be substantially similar, as all of these components may be implemented using a personal computer, for example. Thus, the information management functions described above may be enabled through software installed at a computer system having the general structure of the server 90 of FIG. 3. A processor executes information management software, receives inputs from one or more input devices, and displays information on a display. A transceiver enables communication and exchange of information with remote systems, to provide for information management in accordance with embodiments of the invention.

What has been described is merely illustrative of the application of the principles of the invention. Other arrangements and methods can be implemented by those skilled in the art without departing from the spirit and scope of the present invention.

For example, although systems are described above primarily in the context of a processor which executes software in which the techniques according to the invention have been implemented, embodiments of the invention may instead be implemented with more than a single processor or physical component. The operations disclosed herein may be performed, for example, in separate components or devices, or in other types of components than a processor. References herein to a processor performing various user functions should be interpreted accordingly. Thus, in effect, the processor 94 in FIG. 3 represents one possible implementation of a server information manager which performs various information management and display functions. A processor is also one possible, but not the only, implementation of a patient prompt configuration manager through which user prompts for patient systems are configured as described above.

Similarly, it should be appreciated that components are shown within particular blocks or systems solely for illustrative purposes, and that the functionality disclosed herein may be supported with other system configurations, with different division of functions between system components.

In addition, the GUIs shown in the drawings and described above are illustrative examples of display screens that may be presented to a server user. Other layouts, fonts, content, etc., may be used to implement embodiments of the invention. References to GUIs or graphical elements including certain content should thus be interpreted broadly, to include representations of such content. A GUI might represent a user prompt, for instance, but need not include the exact form of the user prompt as it would be presented at a patient system. Formats, fonts, supporting software code, etc., may be different between GUIs and graphical elements which are used at different system components.

It should also be appreciated that the particular form of the graphical elements described herein is a matter of design. The invention is in no way limited to any specific number or type of graphical elements. For example, although many data entry and control graphical elements have been shown and described as separate graphical elements, these graphical elements may be provided as part of a larger graphical element which defines multiple input areas. Similarly, graphical elements shown and described as having multiple data entry fields and control buttons may be implemented using separate graphical elements corresponding to respective data and control input areas.

Those skilled in the art will also appreciate that references to creating, deleting, or editing components such as groups, care providers, patients, allergies, etc. are intended to indicate operations performed on associated information records.

Although system administrator, group administrator, and care provider server access have been described in detail above, other embodiments of the invention may provide patients with at least read access to patient information. Patients may also be authorized to add, edit, and/or delete their own information.

Other interactions between the elements of a patient monitoring system than those described above may also be supported. For example, a further device that may be associated with a patient system is a pill or medication dispensing unit. Such a unit may be managed by a further system or server to dispense medication to a patient. Where patient medication is monitored by a further system or server, to track how often a patient actually takes scheduled medications, or when a dispensing unit requires refilling, this information may be shared with a patient monitoring system server to generate alarms, for example. In this case, interaction is server to server. Information may also be shared in the other direction in this example. Thus, it will be apparent that a complete patient health management system may include multiple monitoring systems and multiple servers, for example, which may be configured to operate in conjunction with substantially the same patient system or different components of a patient system.

In addition, embodiments of the invention have been described above primarily in the context of systems, methods, and GUIs. Other implementations are also possible, as instructions stored on a machine-readable medium, for instance.

1. A system for managing information in a medical patient health monitoring system, comprising:
a data store for storing health care group information, health care provider information, and medical patient information; and
a server operatively coupled to the data store and configured to receive information for storage in the data store and to store the received information in the data store as at least one of: group information associated with a health care group, health care provider information associated with both a health care provider and a health care group to which the health care provider is assigned, and patient information associated with both a patient and a health care provider to which the patient is assigned, according to a type of the received information.

2. The system of claim 1, wherein the server is configured to receive the information from at least one of: a local input device and a remote system.

3. The system of claim 1, further comprising:
a display,
wherein the server is further configured to display on the display a graphical user interface (GUI) comprising a graphical element defining a user input area, and wherein the received information comprises a user input within the user input area.

4. The system of claim 3, wherein the display is provided at a remote system which is configured to detect the user input within the user input area and to transmit the user input to the server.

5. The system of claim 3, wherein the GUI is associated with a record in the data store, the record corresponding to group information, care provider information, or patient information, and wherein the server is configured to store the received information in the record.

6. The system of claim 5, wherein the GUI comprises an indication of whether the user input area corresponds to group information, care provider information, or patient information.

7. A method of managing medical patient health care information, comprising:
receiving information to be stored in a database for storing health care group information, health care provider information, and medical patient information;
determining whether the received information comprises health care group information, health care provider information, or patient information; and
storing the received information in the database as group information associated with a health care group, as health care provider information associated with both a health care provider and a health care group to which the health care provider is assigned, or as patient information associated with both a patient and a health care provider to which the patient is assigned, based on the determination.

8. The method of claim 7, further comprising:
displaying a graphical user interface (GUI) comprising information stored in the database and a control input area;
detecting a user input within the control input area; and
displaying a further GUI defining a user input area,
wherein receiving comprises detecting a user input within the user input area.

9. A machine-readable medium storing machine-readable instructions which when executed perform the method of claim 7.

10. A machine-readable medium storing a data structure 25 comprising:
a health care group record comprising information associated with a health care group;
a health care provider record associated with the health care group record and comprising information associated with a health care provider; and
a patient record associated with the health care provider record and comprising information associated with a medical patient.

11. The medium of claim 10, wherein the data structure further comprises:
a plurality of health care group records;
a plurality of health care provider records, each associated with a health care group record of the plurality of health care group records and comprising information associated with respective health care providers; and
a plurality of patient records, each associated with a health care provider record of the plurality of health care provider records and comprising information associated with respective patients.

12. A medical health monitoring system comprising:
a data store for storing a central database of patient information for a medical patient, health care provider information for a health care provider of the patient, and health care group information for a health care group to which the health care provider belongs; and
an access system, for accessing the data store and displaying the patient information, the health care provider information, and the health care group information, and configured to display with health care provider information for a health care provider health care group information for the health care group to which the health care provider belongs, and to display with patient information for a patient health care provider information for the health care provider of the patient.

13. The system of claim 12, wherein the access system comprises at least one of: a server operatively coupled to the data store and a remote system configured to communicate with the server to access the database.

14. The system of claim 13, wherein access to the database is controlled based on accounts established at the server, and wherein the server displays or provides to the remote system information stored in the database, based on a type of access account used to access the database.

15. A method of providing access to medical health information, comprising:
determining an access level of a user attempting to access the health information;
allowing the user to select patient information for a medical patient, health care provider information for a health care provider, or health care group information based on the access level; and
displaying patient information with health care provider information for a health care provider of the patient responsive to selection of patient information, displaying health care provider information for a health care provider with health care group information for a health care group to which the health care provider belongs responsive to selection of health care provider information, and displaying health care group information responsive to selection of health care group information.

16. The method of claim 15, wherein allowing comprises displaying one of a health care group information management graphical user interface (GUI), a health care provider information management GUI, or a patient information management GUI, each GUI comprising user input areas for controlling GUI presentation.

17. A machine-readable medium storing machine-readable instructions which when executed perform the method of claim 15.

18. A graphical user interface for a health information management system, comprising:
an information graphical element for displaying patient information for a medical patient, health care provider information for a health care provider, or health care group information for a health care group stored in a medical information database; and
a situational reference graphical element for displaying health care provider information for a health care provider associated with the patient where the information graphical element displays patient information, and for displaying health care group information for a health care group associated with the health care provider where the information graphical element displays health care provider information.

19. A system of configuring user prompts to be presented at a medical patient health monitoring system, comprising:
a display;
an input device; and
a user prompt configuration manager for displaying on the display existing user prompts in a user prompt set, for receiving from the input device a user input of a new user prompt for the user prompt set, and for adding the new user prompt to the user prompt set.

20. The system of claim 19, wherein the user prompt configuration manager is configured to display graphical elements defining respective control input areas corresponding to a plurality of types of user prompts, to detect as a new user prompt control entry input a user input within any of the control input areas, and to display on the display a new user prompt input graphical element responsive to detecting a user input within any of the control input areas.

21. The system of claim 19, wherein the existing user prompts comprise user prompts in a standardized data set available for use in configuring user prompts for a plurality of patients.

22. The system of claim 19, wherein the existing user prompts comprise user prompts assigned to the patient.

23. The system of claim 22, wherein displaying comprises displaying respective user prompt graphical elements comprising the existing user prompts and respective response graphical elements comprising permitted responses to each existing user prompt, and associating respective subordinate user prompt graphical elements, comprising existing user prompts to be presented at the medical patient health monitoring system upon respective predetermined responses to other existing user prompts, on the display with the response graphical elements of the respective predetermined responses to the other user prompts.

24. The system of claim 23, wherein associating comprises displaying each subordinate user prompt graphical element and its corresponding response graphical element with at least one of: a common display attribute, a common vertical display position, and a common horizontal display position.

25. The system of claim 23, wherein the response graphical elements comprise control input graphical elements defining respective control input areas, and wherein the user prompt configuration manager is further configured to display on the display a new user prompt input graphical element responsive to detecting a user input within any of the control input areas, and to associate a new user prompt, entered using the new user prompt input graphical element, on the display with the response graphical element comprising the control input graphical element which defines the control input area in which the user input was detected.

26. A method of configuring user prompts to be presented at a medical patient health monitoring system, the method comprising:
displaying existing user prompts in a user prompt set;
receiving an input of a new user prompt for the user prompt set; and
adding the new user prompt to the user prompt set.

27. The method of claim 26, further comprising:
displaying user prompts in a standardized data set available for use in configuring user prompts for a plurality of patients,
wherein receiving comprises receiving a selection of a user prompt in the standardized user prompt set.

28. The method of claim 26, wherein the existing user prompts comprise subordinate user prompts to be presented at the medical patient health monitoring system upon respective predetermined responses to other existing user prompts, and wherein displaying comprises associating each subordinate user prompt with its corresponding predetermined response.

29. The method of claim 28, wherein the new user prompt comprises a subordinate user prompt to be presented at the patient monitoring system upon a predetermined response to one of the displayed existing user prompts.

30. A machine-readable medium storing machine-readable instructions which when executed perform the method of claim 26.

31. A graphical user interface comprising:
a graphical element comprising user prompts to be presented at a medical patient health monitoring system; and
an input graphical element defining an input area for configuring the user prompts.

32. The graphical user interface of claim 31, wherein the graphical element comprises:
respective user prompt graphical elements comprising user prompts to be presented at the medical patient health monitoring system;
respective response graphical elements comprising permitted responses to each user prompt; and
respective subordinate user prompt graphical elements comprising user prompts to be presented at the medical patient health monitoring system upon predetermined responses to other user prompts, each subordinate user prompt being associated on a display with a response graphical element of a predetermined response to another user prompt.
